(19) United States
(12) Patent Application Publication
(10) Pub. No.: US 2025/0162890 A1
(43) Pub. Date: May 22, 2025

(54) SYNTHESIS OF HIERARCHICAL ZEOLITES VIA A NON-CLASSICAL GROWTH MECHANISM IN THE PRESENCE OF ODSO

(71) Applicant: SAUDI ARABIAN OIL COMPANY, Dhahran (SA)

(72) Inventors: Robert P. Hodgkins, Dhahran (SA); Omer R. Koseoglu, Dhahran (SA); Moussa Zaarour, Thuwal (SA); Javier Ruiz Martinez, Thuwal (SA)

(73) Assignee: SAUDI ARABIAN OIL COMPANY, Dhahran (SA)

(21) Appl. No.: 18/514,145

(22) Filed: Nov. 20, 2023

(51) Int. Cl. C01B 39/40; C01B 39/20; C01B 39/48

(52) U.S. Cl. CPC C01B 39/40; C01B 39/205; C01B 39/48; C01P 2002/72; C01P 2002/76; C01P 2004/03; C01P 2006/12; C01P 2006/14

(57) ABSTRACT

The present disclosure is directed to a method of manufacture of zeolite by a non-classical route. A sol-gel process includes an initial homogeneous aqueous mixture comprising precursors and reagents for forming the zeolite, and water-soluble oxidized disulfide oil (ODSO) as an additional component. The resulting zeolite possesses a hierarchical nature that is improved relative to a comparative zeolite formed in the absence of ODSO, via a classical route, and of approximately equivalent compositional ratio, time and conditions effective for the zeolite.

### FIELD OF THE DISCLOSURE

The present disclosure relates to synthesis of zeolites.

### BACKGROUND OF THE DISCLOSURE

Zeolites are crystalline solids possessing well-defined structures and uniform pore sizes that can be measured in angstroms (Å). Typically, zeolites comprise framework atoms such as silicon, aluminum and oxygen arranged as silica and alumina tetrahedra. Zeolites are generally hydrated aluminum silicates that can be made or selected with a controlled porosity and other characteristics, and typically contain cations, water and/or other molecules located in the porous network. Hundreds of natural and synthetic zeolite framework types exist with a wide range of applications. Numerous zeolites occur naturally and are extensively mined, whereas a wealth of interdependent research has resulted in an abundance of synthetic zeolites of different structures and compositions. The unique properties of zeolites and the ability to tailor zeolites for specific applications has resulted in the extensive use of zeolites in industry as catalysts, molecular sieves, adsorbents, ion exchange materials and for the separation of gases. Certain types of zeolites find application in various processes in petroleum refineries and many other applications. The zeolite pores can form sites for catalytic reactions, and can also form channels that are selective for the passage of certain compounds and/or isomers to the exclusion of others. Zeolites can also possess an acidity level that enhances its efficacy as a catalytic material or adsorbent, alone or with the addition of active components.

Zeolite Y (also known as Na—Y zeolite or Y-type faujasite zeolite) is a well-known material for its zeolites have ion-exchange, catalytic and adsorptive properties. Zeolite Y is also a useful starting material for production of other zeolites such as ultra-stable Y-type zeolite (USY). Like typical zeolites, faujasite is synthesized from alumina and silica sources, dissolved in a basic aqueous solution and crystallized. The faujasite zeolite has a framework designated as FAU by the International Zeolite Association, and are formed by 12-ring structures and have channels of about 7.4 angstroms (Å). Faujasite zeolites are characterized by a 3-dimensional pore structure with pores running perpendicular to each other in the x, y, and z planes. Secondary building units can be positioned at 4, 6, 6-2, 4-2, 1-4-4 or 6-6. An example SAR range for faujasite zeolite is about 2 to about 6, typically with a unit cell size (units a, b and c) in the range of about 24.25 to 24.85 Å. Faujasite zeolites are typically considered X-type when the silica-to-alumina ratio (SAR) is at about 2-3, and Y-type when the SAR is greater than about 3, for instance about 3-6. The faujasite is in its sodium form and can be ion exchanged with ammonium, and the ammonium form can be calcined to transform the zeolite to its proton form.

ZSM-5 zeolites are a type of zeolite having an MFI framework, an orthorhombic structure and belonging to the pentasil family. The general formula is NaₙAlₙSi₉₆₋ₙO₁₉₂·16H₂O (0<n<27)). ZSM-5 zeolites have pore dimensions that results in the formation of channels of suitable size and shape for selective passage for xylene isomers. For example, in a mixture of p-, o- and m-xylenes, p-xylene readily passes through the channels of ZSM-5 catalysts due to its linear configuration, while diffusion of o-xylene and m-xylene is hindered. Methods for preparing ZMS-5 are known. For example. U.S. Pat. No. 3,702,886, the entire contents of which are incorporated herein by reference, discloses a process for preparing ZSM-5 using a mixture of alkali metal cations and tetraalkylammonium cations, such as tetrapropylammonium (TPA) cations as a template or structure directing agent to direct the synthesis of the ZSM-5 structure. Numerous variations of this method are known, and it is appreciated that the physical and catalytic properties of the ZSM-5 can be highly dependent upon the method by which it is manufactured.

Zeolite beta (*BEA) (where *BEA is the code established by the International Zeolite Association) contains the *BEA framework, which includes zeolite beta polymorph A, having a micropore size related to the 12-member rings when viewed along the [100] and [001] directions of 6.6×6.7 Å and 5.6×5.6 Å, respectively. Beta zeolites are known as highly acidic zeolites in the hydrogen-exchanged form. Numerous methods have been reported for the synthesis of zeolite beta. An example of the synthesis of zeolite beta uses the tetraethylammonium ion as a structure directing agent.

Properties for ZSM-5 zeolite, zeolite Y and zeolite beta listed in Table 1. A person skilled in the art will recognize that unit cell parameters can vary slightly depending on framework composition such as the silica-to-alumina ratio (SAR).

Whereas zeolites have found great utility in their ability to select between small molecules and different cations, mesoporous solids (pores between about 20 and 500 Å) offer possibilities for applications for species up to an order of magnitude larger in dimensions such as nanoparticles and enzymes. The comparatively bulky nature of such species hinders diffusion through the microporous zeolite network, and thus, a larger porous system is required to effectively perform an analogous molecular sieving action for the larger species.

Mesoporous silicas are amorphous; however, it is the pores that possess long-range order with a periodically aligned pore structure and uniform pore sizes on the mesoscale. Mesoporous silicas offer high surface areas and can be used as host materials to introduce additional functionality for a diverse range of applications such as adsorption, separation, catalysis, drug delivery and energy conversion and storage.

An attractive property of ordered structures is that their architecture may be described in relation to their symmetry. The regular form of crystals is associated with the regular arrangements of the sub-units comprising the crystal, and hence, the symmetry of the crystal is connected to the symmetry of the sub-units. For example, seven distinct three-dimensional crystal units are provided in Table 2. The crystal systems can be sub-divided upon the symmetry elements present, collectively referred to as the point group and provided in Table 3. For example, 3m infers that a mirror plane having a three-fold axis is present. For the class 3/m (or 6) the mirror plane is perpendicular to the three-fold axis. In 2D space, such as a lamellar system, having fewer dimensions than 3D, there are four crystal systems: hexagonal, square, rectangular and oblique.

The well-defined microporous structure of zeolites provides an amalgam of important physicochemical functionalities that are highly desirable in various industrial practices. Their molecular-sized pore channels embedded with tunable acid/base sites can geometrically discriminate the ingress of guest species and direct shape-selective transformations. Such remarkable properties uniquely exhibited by zeolites demonstrate unprecedented importance in numerous chemical technologies, including but not limited to oil-refining, detergents and effluent abatement, that profoundly impact the global economy and environment. However, zeolite performance is often hindered as a result of their poor mass-transfer abilities induced by configurational diffusion inside the narrow micropores. Therefore, mitigation of the intrinsic mass-transfer limitations is important to explore the full potential of zeolites in diverse energy economies and thereby enhance the accessibility to internal functional sites. Other drawbacks of microporous zeolites as catalysts in certain reactions are their susceptibility to coking, which can lead to accelerated deactivation of catalysts and product selectivity.

In this regard, hierarchical zeolites possessing a mesoporous structure and zeolitized mesopore walls are of great technological importance due to their exceptional properties. Hierarchical zeolites contain different layers of porosity, that is, mesopores and micropores. Hierarchical zeolites offer advantages over traditional microporous zeolites by, for example, improving diffusion of guest species to the active sites, overcoming steric limitations, improving product selectivity, decreasing coke formation, improving hydrothermal stability, and improving accessibility of Brønsted acid sites and Lewis acid sites; and concomitantly, improved catalytic performance.

Numerous synthetic strategies to produce hierarchical zeolites are known, and fall under two general categories: bottom-up approaches which include the use of hard templates and soft templates, and top-down approaches which typically involve post-synthetic treatment. Bottom-up strategies generally involve templating techniques used in situ during zeolite crystallization, for example using hard templates (carbon sources) or soft templates (surfactants). Top-down strategies generally involve post-synthetic modifications of already formed zeolite crystals, for example, by steaming, dealumination (using an acid) or desilication (using a base).

Zeolites can be formed and crystallized via classical or non-classical growth mechanisms (see Bai, Risheng, Yue Song, Lukas Latsch, Yongcun Zou, Zhaochi Feng, Christophe Copéret, Avelino Corma and Jihong Yu. “Switching between classical/nonclassical crystallization pathways of TS-1 zeolite: implication on titanium distribution and catalysis.” Chemical Science 13 (2022): 10868-10877). In classical pathways monomers are added to the kink, step and terrace sites on the zeolite surface resulting in smooth surfaces. In contrast, for non-classical pathways, larger entities from oligomers to primary particles are added resulting in zeolite particles possessing textured surfaces of a hierarchical nature. Therefore, controlling the switch between classical and non-classical growth mechanisms is a way to design the physico-chemical properties of zeolites. Factors that may influence switching between classical and non-classical growth are, but not limited to, the kinetics behind crystal nucleation (see FIG. 1) and the degree of structure of amorphous silica precursors. These factors can control the distribution of heteroatoms, which can then further impact on catalytic performance for the same composition.

As with all zeolite synthesis, there are various precursors, reagents and utilities (including utility water) used in certain compositional ratios to produce the desired framework. Within a typical refinery, there are by-product streams that must be treated or otherwise disposed of. One of these is a by-product stream from mercaptan oxidation processes, commonly referred to as the MEROX process, which has long been employed for the removal of the generally foul smelling mercaptans found in many hydrocarbon streams and was introduced in the refining industry over fifty years ago. Because of regulatory requirements for the reduction of the sulfur content of fuels for environmental reasons, refineries have been, and continue to be faced with the disposal of large volumes of sulfur-containing by-products. Disulfide oil (DSO) compounds are produced as a by-product of the MEROX process, in which the mercaptans are removed from any of a variety of petroleum streams including liquefied petroleum gas, naphtha, and other hydrocarbon fractions. It is commonly referred to as a “sweetening process” because it removes the sour or foul smelling mercaptans present in crude petroleum. The term “DSO” is used for convenience in this description and in the claims, and will be understood to include the mixture of disulfide oils produced as by-products of the mercaptan oxidation process. Examples of DSO include dimethyldisulfide, diethyldisulfide, and methylethyldisulfide.

The by-product DSO compounds produced by the MEROX unit can be processed and/or disposed of during the operation of various other refinery units. For example, DSO can be added to the fuel oil pool at the expense of a resulting higher sulfur content of the pool. DSO can be processed in a hydrotreating/hydrocracking unit at the expense of higher hydrogen consumption. DSO also has an unpleasant foul or sour smell, which is somewhat less prevalent because of its relatively lower vapor pressure at ambient temperature; however, problems exist in the handling of this oil.

Commonly owned U.S. Pat. No. 10,807,947 which is incorporated by reference herein in its entirety discloses a controlled catalytic oxidation of MEROX process by-products DSO. The resulting oxidized material is referred to as oxidized disulfide oil (ODSO). As disclosed in 10,807,947, the by-product DSO compounds from the mercaptan oxidation process can be oxidized, preferably in the presence of a catalyst. The oxidation reaction products constitute an abundant source of ODSO compounds, sulfoxides, sulfonates, sulfinates and sulfones.

The ODSO stream so-produced contains ODSO compounds as disclosed in U.S. Pat. Nos. 10,781,168 and 11,111,212 as compositions (such as a solvent), in U.S. Pat. No. 10,793,782 as an aromatics extraction solvent, and in U.S. Pat. No. 10,927,318 as a lubricity additive, all of which are incorporated by reference herein in their entireties. In the event that a refiner has produced or has on hand an amount of DSO compounds that is in excess of foreseeable needs for these or other uses, the refiner may wish to dispose of the DSO compounds in order to clear a storage vessel and/or eliminate the product from inventory for tax reasons.

Thus, there is a clear and long-standing need to provide an efficient and economical process for the treatment of DSO by-products and their derivatives to effect and modify their properties in order to facilitate and simplify their environmentally acceptable disposal, and to utilize the resultant modified products in an economically and environmentally friendly manner such as in the synthesis in new materials, and thereby enhance the value of this class of by-products to the refiner.

### SUMMARY OF THE DISCLOSURE

In certain embodiments, a method for the synthesis of a zeolite is provided. The method comprises forming a homogeneous aqueous mixture of a silica source, an optional alumina source, an alkali metal source, an optional structure directing agent, water and water-soluble oxidized disulfide oil (ODSO). The mixture is heated under conditions and for a time effective to form a precipitate suspended in a supernatant, wherein the precipitate comprises the zeolite. The zeolite is hierarchical.

In some embodiments, the homogeneous aqueous mixture is formed at a compositional ratio effective for the zeolite, wherein a cumulative mass of ODSO and water is equivalent to a mass of water that is effective to produce the zeolite. In some embodiments, the hierarchical zeolite has a property that is enhanced with respect to that of a comparative zeolite formed in the absence of ODSO and of approximately equivalent compositional ratio, time and conditions effective for the zeolite.

In certain embodiments, a method for the synthesis of a zeolite is provided. The method comprises forming a homogeneous aqueous mixture of a silica source, an optional alumina source, alkali metal source, an optional structure directing agent, water and water-soluble oxidized disulfide oil (ODSO). The mixture is heated under conditions and for a time effective to form a precipitate suspended in a supernatant, wherein the precipitate comprises the zeolite. The zeolite is formed by a non-classical route. In some embodiments, a comparative zeolite having a baseline ratio of components including a baseline mass of water and which is formed in the absence of ODSO is formed via a classical route, and wherein a mass of ODSO is of a value such that a cumulative mass of the water in and the mass of ODSO is equivalent to the baseline mass of water.

In some embodiments, the mixture is aged for a predetermined period of time before the heating. In some embodiments, the predetermined period of time is in the range of from about 0.5-72, 0.5-48, 0.5-24, 6-72, 6-48 or 6-24 hours.

In some embodiments, the non-classical route comprises attaching one or more oligomers, primary particles, nanoparticles or other species larger than monomers from the homogeneous aqueous mixture to the zeolite. In some embodiments, the species larger than monomers include Si, molecules containing Si, one or more heteroatoms, hydroxides of one or more heteroatoms, oxides of one or more heteroatoms, salts of one or more heteroatoms, or combinations thereof, wherein the one or more heteroatoms are selected from the group consisting of Al, Ti, Zr, Hf, Ge, Ga, Cu, Fe, B, P, Sn, Zn, and In. In some embodiments, the zeolite has a unit cell size and the one or more oligomers, primary particles, nanoparticles or other species larger than monomers has a size that is larger than the unit cell size.

In some embodiments, the zeolite is formed at a crystallization rate that is greater than that of a comparative zeolite having a baseline ratio of components including a baseline mass of water and which is formed in the absence of ODSO.

In some embodiments, the property that is enhanced is a specific surface area, a total pore volume, a mesoporous volume, a relative contribution of mesopores to a total volume of the zeolite, a mesopore surface area, a relative contribution of mesopores to a total surface area of the zeolite, or a combination thereof. In some embodiments, the specific surface area of the zeolite is in the range of about 1-200, 10-200, 50-200, 1-150, 10-150, 50-150, 1-100, 10-100, or 50-100% greater than a comparative zeolite that is formed in the absence of ODSO of approximately equivalent compositional ratio effective for the zeolite except for water instead of the added ODSO. In some embodiments, the total pore volume of the zeolite is in the range of about 1-200, 10-200, 50-200, 1-150, 10-150, 50-150, 1-100, 10-100, or 50-100% greater than a comparative zeolite that is formed in the absence of ODSO of approximately equivalent compositional ratio effective for the zeolite except for water instead of the added ODSO. In some embodiments, the mesoporous volume of the zeolite is in the range of about 1-200, 10-200, 50-200, 1-150, 10-150, 50-150, 1-100, 10-100, or 50-100% greater than a comparative zeolite that is formed in the absence of ODSO of approximately equivalent compositional ratio effective for the zeolite except for water instead of the added ODSO. In some embodiments, the relative contribution of mesopores to a total volume of the zeolite is in the range of about 1-150, 10-150, 50-150, 1-100, 10-100, 50-100, 1-50, or 10-50% greater than a comparative zeolite that is formed in the absence of ODSO of approximately equivalent compositional ratio effective for the zeolite except for water instead of the added ODSO. In some embodiments, the mesopore surface area of the zeolite is in the range of about 1-750, 100-750, 300-750, 1-500, 100-500, 300-500, 1-400, 100-400, or 300-400% greater than a comparative zeolite that is formed in the absence of ODSO of approximately equivalent compositional ratio effective for the zeolite except for water instead of the added ODSO. In some embodiments, the relative contribution of mesopores to a total surface area of the zeolite is in the range of about 1-400, 50-400, 100-400, 1-300, 50-300, 100-300, 1-200, 50-200, or 100-200% greater than a comparative zeolite that is formed in the absence of ODSO of approximately equivalent compositional ratio effective for the zeolite except for water instead of the added ODSO.

In some embodiments, an ODSO is added in an amount by mass of ODSO, relative to the total mass of “free” water and ODSO, in the range of from about 0.1 to 50%, 0.1 to 20%, 0.1 to 15%, 0.1 to 10% or 0.1 to 5%. In some embodiments, ODSO is added in an amount by mass of ODSO, relative to the total mass of water and ODSO, in the range of from about 0.5 to 17%, 0.5 to 10%, 0.5 to 7.5%, 0.5 to 5% or 0.5 to 3%.

In some embodiments, the alkali metal source comprises sodium, and wherein the zeolite has an ODSO to sodium ratio (wt./wt.) in the range of about 0.01-11, 0.01-10, 0.01-9, 0.01-8, 0.01-7, 0.01-6, 0.01-5, 0.01-4, 0.01-3, 0.01-2, 0.01-1, 0.01-0.1, 0.1-11, 0.1-10, 0.1-9, 0.1-8, 0.1-7, 0.1-6, 0.1-5, 0.1-4, 0.1-3, 0.1-2, 0.1-1, 1-11, 1-10, 1-9, 1-8, 1-7, 1-6, 1-5, 1-4, 1-3, 1-2, 2-11, 2-10, 2-9, 2-8, 2-7, 2-6, 2-5, 2-4 or 2-3.

In some embodiments, the zeolite has a morphology that comprises an agglomeration of individual zeolite particles characterized by an agglomeration average dimension, and wherein each individual zeolite particle is characterized by an average dimension that is about 1-99% smaller than the agglomeration average dimension. In some embodiments, the average dimension means the size of the individual zeolite particle in the x-, y-, or z-direction, where x, y, and z are mutually orthogonal to each other. In some embodiments, the hierarchal nature of the agglomeration of individual particles is characterized by the micropores of the underlying zeolite, the mesopores created in the interstitial areas in between the particles (inter-mesopores) and mesopores created within an individual particle (intra-mesopores). Inter-mesopores can be observed in nitrogen adsorption isotherms by an inflection point at about 0.95 P/P₀. This indicates a high uptake of adsorbate over a narrow pressure range since the voids/pores at the interstitial sites are comparatively larger in diameter than voids/pores from intra-mesopores. Intra-mesopores can be observed in nitrogen adsorption isotherms by a hysteresis loop at lower pressure ranges.

In some embodiments, the zeolite possesses MFI, FAU, or *BEA, frameworks. In some embodiments, the zeolite possesses FAU framework and comprises zeolite Y or ultra-stable zeolite Y (USY). In some embodiments, the zeolite possesses *BEA framework. In some embodiments, the zeolite possesses MFI framework and is ZSM-5, Silicalite-1 or TS-1.

In some embodiments, the zeolite is a ZSM-5 zeolite and the mass ratio of ODSO to sodium from the alkali metal source is in the range of about 0.1-10. In some embodiments, the zeolite is a *BEA zeolite and the mass ratio of ODSO to sodium from the alkali metal source is in the range of about 0.1-10. In some embodiments, the zeolite is a FAU zeolite and the mass ratio of ODSO to sodium from the alkali metal source is in the range of about 0.1-2.7.

In some embodiments, the zeolite is a ZSM-5 zeolite and ODSO is added in an amount by mass of ODSO, relative to the total mass of water and ODSO, in the range of from about 3 to 15%. In some embodiments, the zeolite is a *BEA zeolite and ODSO is added in an amount by mass of ODSO, relative to the total mass of water and ODSO, in the range of from about 0.1 to 17%. In some embodiments, the zeolite is a FAU zeolite and ODSO is added in an amount by mass of ODSO, relative to the total mass of water and ODSO, in the range of from about 1 to 12%.

In some embodiments, the structure directing agent is included in the homogeneous aqueous mixture, and wherein the structure directing agent is one or more of quaternary ammonium ions, trialkylamines, dialkylamines, monoalkylamines, cyclic amines, alkylethanol amines, cyclic diamines, alkyl diamines, alkyl polyamines, and other templates including alcohols, ketones, morpholine and glycerol. In some embodiments, the homogeneous aqueous mixture further comprises a seed material. For example: for MFI zeolites, suitable seed materials include ZSM-5 (MFI), ZSM-8 (MFI), ZSM-11 (MEL) and Silicalite-1 (MFI); for beta zeolites, other beta zeolites are used as seed materials; for mordenite zeolites, other mordenite zeolites are used as seed materials; for FAU zeolites, suitable seed materials are zeolite Y, zeolite X, USY zeolite, faujasite zeolite or small protozeolitic species (gels). In some embodiments, the silica source can comprise one or more of silicates including sodium silicate (water glass), rice husk, fumed silica, precipitated silica, colloidal silica, silica gels, other zeolites, dealuminated zeolites, and silicon hydroxides and alkoxides. In some embodiments, the alumina source is included in the homogeneous aqueous mixture, and wherein the alumina source can comprise one or more of aluminates, alumina, other zeolites, aluminum colloids, boehmites, pseudo-boehmites, aluminum salts such as aluminum nitrate, aluminum sulfate and alumina chloride, aluminum hydroxides and alkoxides, aluminum wire and alumina gels. In some embodiments, an effective amount of water for the homogeneous aqueous mixture is provided by using utility water, a water-containing silica source, and/or by using an aqueous mixture of the aluminum oxide source, the alkali metal source and the structure directing agent.

In some embodiments, the heating is under conditions comprising an operating pressure in the range of from atmospheric pressure to 17 bar or is at autogenous pressure, an operating temperature in the range of from 90° C. to 220° C., and an operating time in the range of from 0.1 to 14 days.

In some embodiments, the ODSO is derived from oxidation of disulfide oil compounds present in an effluent refinery hydrocarbon stream recovered following catalytic oxidation of mercaptans present in a mercaptan-containing hydrocarbon stream. In some embodiments, the one or more ODSO compounds comprise ODSO compounds having 3 or more oxygen atoms. In some embodiments, the one or more ODSO compounds comprise ODSO compounds having 1 to 20 carbon atoms. In some embodiments, the one or more ODSO compounds are in a mixture having an average density greater than about 1.0 g/cc. In some embodiments, the one or more ODSO compounds are in a mixture having an average boiling point greater than about 80° C. In some embodiments, the ODSO compounds have 3 or more oxygen atoms and include one or more compounds selected from the group consisting of (R—SOO—SO—R′), (R—SOO—SOO—R′), (R—SO—SOO—OH), (R—SOO—SOO—OH), (R—SOO—SO—OH), (R′—SO—SO—OR), (R′—SOO—SO—OR), (R′—SO—SOO—OR) and (R′—SOO—SOO—OR), wherein R and R′ can be the same or different C1-C10 alkyl or C6-C10 aryl. In some embodiments, the ODSO compounds have 3 or more oxygen atoms and include two or more compounds selected from the group consisting of (R—SOO—SO—R′), (R—SOO—SOO—R′), (R—SO—SOO—OH), (R—SOO—SOO—OH), (R—SOO—SO—OH), (R′—SO—SO—OR), (R′—SOO—SO—OR), (R′—SO—SOO—OR) and (R′—SOO—SOO—OR), wherein R and R′ can be the same or different C1-C10 alkyl or C6-C10 aryl. In some embodiments, the ODSO compounds have 3 or more oxygen atoms and include one or more compounds selected from the group consisting of (R—SOO—SO—R′), (R—SOO—SOO—R′), (R—SO—SOO—OH), (R—SOO—SOO—OH), (R—SO—SO—OH), (R—SOO—SO—OH), wherein R and R′ can be the same or different C1-C10 alkyl or C6-C10 aryl. In some embodiments, the ODSO compounds have 3 or more oxygen atoms and include two or more compounds selected from the group consisting of (R—SOO—SO—R′), (R—SOO—SOO—R′), (R—SO—SOO—OH), (R—SOO—SOO—OH), (R—SO—SO—OH), (R—SOO—SO—OH), wherein R and R′ can be the same or different C1-C10 alkyl or C6-C10 aryl.

Any combinations of the various embodiments and implementations disclosed herein can be used. These and other aspects and features can be appreciated from the following description of certain embodiments and the accompanying drawings and claims.

### BRIEF DESCRIPTION OF THE DRAWINGS

FIG. 1 is a schematic showing two zeolite growth mechanisms, via classical formation and via non-classic formation.

FIG. 2 is a simplified schematic diagram of a generalized version of a conventional mercaptan oxidation or MEROX process for the liquid-liquid extraction of a mercaptan containing hydrocarbon stream.

FIG. 3 is a simplified schematic diagram of a generalized version of an enhanced mercaptan oxidation or E-MEROX process.

FIG. 4A is the experimental ¹H-NMR spectrum of the polar, water-soluble ODSO fraction used in examples herein.

FIG. 4B is the experimental ¹³C-DEPT-135-NMR spectrum of the polar, water-soluble ODSO fraction used in examples herein.

FIG. 5 shows XRD diffraction patterns of zeolite beta products.

FIG. 6 is a SEM micrograph of calcined zeolite beta synthesized in the absence of ODSO.

FIG. 7 is a SEM micrograph of calcined zeolite beta synthesized in the presence of ODSO.

FIG. 8 is a graph showing nitrogen adsorption isotherms of the calcined zeolite beta products of a comparative example and an example herein.

FIG. 9 shows XRD diffraction patterns of zeolite Y products.

FIG. 10 is a SEM micrograph of zeolite Y synthesized in the absence of ODSO.

FIG. 11 is a SEM micrograph of zeolite Y synthesized in the presence of ODSO.

FIG. 12 shows XRD diffraction patterns of ZSM-5 zeolite products.

FIG. 13 is a SEM micrograph of calcined zeolite ZSM-5 synthesized in the absence of ODSO.

FIG. 14 is a SEM micrograph of calcined ZSM-5 zeolite synthesized in the presence of ODSO.

FIG. 15 is a graph showing nitrogen adsorption isotherms of the calcined ZSM-5 zeolites of a comparative example and an example herein.

FIG. 16 shows XRD diffraction patterns of (ANA) material from synthesized in the absence of ODSO and the ZSM-5 products when synthesized in the presence of ODSO, using approximately equivalent compositional ratios of precursors and reagents other than ODSO.

FIG. 17 is a SEM micrograph of calcined ZSM-5 zeolite synthesized in the presence of a low loading of ODSO.

FIG. 18 is a SEM micrograph of calcined ZSM-5 zeolite synthesized in the presence of a higher loading of ODSO.

FIG. 19 is a graph showing nitrogen adsorption isotherms of the calcined ANA product of a comparative example and calcined ZSM-5 zeolite products of examples herein.

### DETAILED DESCRIPTION OF CERTAIN EMBODIMENTS OF THE DISCLOSURE

The present disclosure is directed to a method of manufacture of zeolite by a non-classical route. A sol-gel process includes an initial homogeneous aqueous mixture comprising precursors and reagents for forming the zeolite, and water-soluble oxidized disulfide oil (ODSO) as an additional component. The resulting zeolite possesses a hierarchical nature that is improved relative to a comparative zeolite formed in the absence of ODSO, via a classical route, and of approximately equivalent compositional ratio, time and conditions effective for the zeolite.

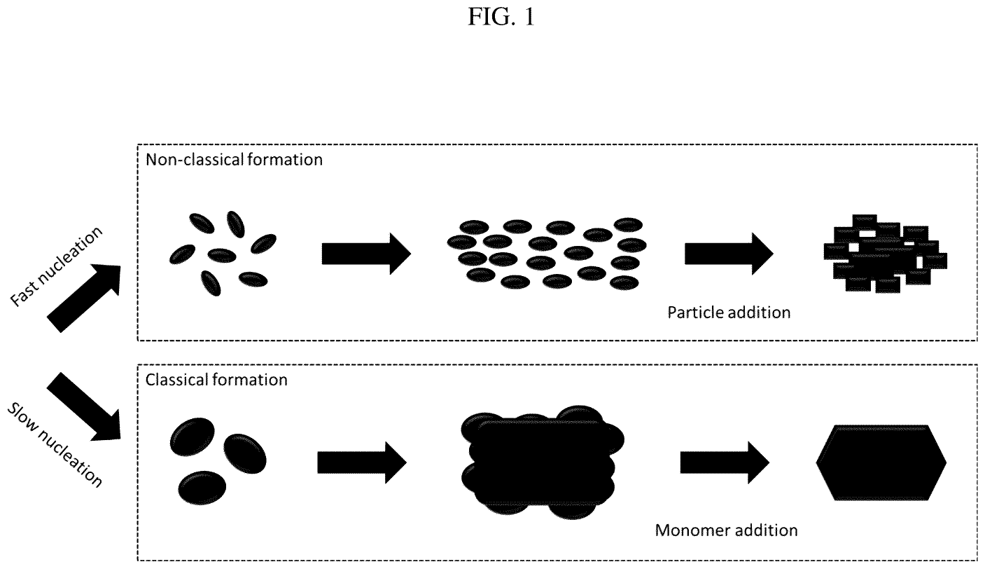

Conventionally zeolites can be formed and crystallized via classical or non-classical growth mechanisms (see Bai, Risheng, Yue Song, Lukas Latsch, Yongcun Zou, Zhaochi Feng, Christophe Coperet, Avelino Corma and Jihong Yu. “Switching between classical/nonclassical crystallization pathways of TS-1 zeolite: implication on titanium distribution and catalysis.” Chemical Science 13 (2022): 10868-10877). In a classical pathway, monomers are added to the kink, step and terrace sites on the zeolite surface resulting in smooth surfaces. In contrast, for non-classical pathways, larger entities from oligomers to primary particles are added resulting in zeolite particles possessing textured surfaces of a hierarchical nature. Therefore, controlling the switch between classical and non-classical growth mechanisms is a way to design the physico-chemical properties of zeolites. Factors that may influence switching between classical and non-classical growth are, but not limited to, the kinetics behind crystal nucleation (see FIG. 1) and the degree of structure of amorphous silica precursors. These factors can control the distribution of heteroatoms, which can then further impact on catalytic performance for the same composition. In the processes herein, the presence and/or quantity of ODSO used in the initial sol-gel influences switching between classical and non-classical zeolite crystallization pathways.

The non-classical route of zeolite synthesis comprises attaching one or more oligomers, primary particles, nanoparticles or other species larger than monomers from the homogeneous aqueous mixture to the zeolite. In certain embodiments, the species larger than monomers include Si, molecules containing Si, one or more heteroatoms, hydroxides of one or more heteroatoms, oxides of one or more heteroatoms, salts of one or more heteroatoms, or combinations thereof. In certain embodiments one or more heteroatoms are selected from the group consisting of Al, Ti, Zr, Hf, Ge, Ga, Cu, Fe, B, P, Sn, Zn, and In. In certain embodiments the zeolite has a unit cell size and the one or more oligomers, primary particles, nanoparticles or other species larger than monomers has a size that is larger than the unit cell size.

In conventional synthesis of materials, water is used as an aqueous medium and as a solvent. In the embodiments of the present disclosure, an effective amount of water-soluble ODSO compounds is added within a homogeneous aqueous mixture. Methods for the preparation of materials of various types are known and discussed herein for reference, but it is understood that variations of that which is disclosed herein can benefit from the use of a water-soluble ODSO component. In certain embodiments, the ODSO is derived from a sulfur-containing refinery waste stream of disulfide oil and is used as a co-solvent in the process of synthesizing one or more zeolites.

In the embodiments herein, the type of material (e.g., zeolite or amorphous material), and sub-type of material (e.g., zeolite framework) within a given material type, can be controlled by one or more factors including but not limited to the precursor and reagent selections and ratios (for example, silica to alumina ratio), pH of the sol-gel, and aging time (if any). In certain embodiments herein, the addition of the water soluble ODSO component in the synthesis process results in a different sub-type or even type of material as compared to an equivalent process in the absence of the added water soluble ODSO component. In certain embodiments herein, the compositional ratios of the precursors and reagents can be similar to those used in synthesis of similar products in the absence of the water soluble ODSO component herein.

In embodiments herein, the synthesis of zeolites includes in its sol-gel a water-soluble ODSO component. The water-soluble ODSO component can be in the form of a neat water-soluble ODSO, as an aqueous water-soluble ODSO solution, a mixture with an alkaline source as a pH modified water-soluble ODSO composition, and/or a supernatant from a prior synthesis using water-soluble ODSO. In embodiments herein, synthesis of zeolites includes an aqueous water-soluble ODSO composition that contributes a portion of requisite utility water for the sol-gel, wherein the water-soluble ODSO composition is used in place of a certain amount of water. In embodiments herein, synthesis of zeolites includes a water-soluble ODSO composition that contributes all or a portion of requisite alkali metal or mineralizer for the sol-gel, for example, using a pH-modified water-soluble ODSO composition comprising an aqueous mixture of one or more water-soluble ODSO compounds and an effective amount of an alkaline agent as disclosed in co-pending and commonly owned U.S. patent application Ser. No. 17/850,158 filed on Jun. 27, 2022, entitled “pH-Modified Water-Soluble Oxidized Disulfide Oil Compositions” and Ser. No. 17/850,115 filed on Jun. 27, 2022, entitled “Method of Zeolite Synthesis Including pH-Modified Water-Soluble Oxidized Disulfide Oil Compositions” which are incorporated by reference herein in their entireties. In certain embodiments the water-soluble ODSO component is provided as a pH-modified water-soluble ODSO composition, and is used in place of all or a portion of requisite alkali metal or mineralizer for zeolite synthesis, and in place of a certain amount of water (including all or a portion of utility water). In embodiments herein, synthesis of zeolites includes supernatant from a prior synthesis that utilized water-soluble ODSO as a component in place of a certain amount of utility water, and all or a portion of the requisite alkali metal or mineralizer, for example as disclosed in co-pending and commonly owned U.S. patent application Ser. No. 17/850,285 filed on Jun. 27, 2022, entitled “Method of Synthesizing Materials Integrating Supernatant Recycle” which is incorporated by reference herein in its entirety.

An effective amount of water for the aqueous environment and as a solvent during the sol-gel process can be provided from one or more water sources, including utility water that is added to form the homogeneous aqueous mixture, a water-containing silica source such as colloidal silica, an aqueous mixture of an alumina source, an aqueous mixture of an alkali metal source, and/or an aqueous mixture of an optional structure directing agent. These mixture components are added with water to the reaction vessel prior to heating. Typically, water allows for adequate mixing to realize a more homogeneous distribution of the sol-gel components, which ultimately produces a more desirable product because each crystal is more closely matched in properties to the next crystal. Insufficient mixing could result in undesirable “pockets” of highly concentrated sol-gel components, and this may lead to impurities in the form of different structural phases or morphologies. Water also determines the yield per volume. In the descriptions that follow, it is understood that water is a component of homogeneous aqueous mixtures from one or more of the sources of water.

In embodiments herein, a portion of the effective amount of water required for sol-gel synthesis is replaced with a water soluble ODSO. The water that is replaced with water soluble ODSO can be all or a portion of the utility water that would typically be added.

In some embodiments, the precursors and reagents effective for the zeolite comprise a silica source, an aluminum source, an alkali metal source, an optional structure directing agent and an optional seed material. Without wishing to be bound by theory, a generalized idea for the mechanism of zeolite crystallization is that nucleation of individual particles precedes zeolite crystal growth. The nucleation phase results in discrete entities of the new phase to which nutrients attach allowing for zeolite growth that follows a classic S-shape crystallization curve.

The present disclosure is applicable to various types of zeolites that are synthesized hydrothermally, which can benefit from inclusion of ODSO components as described herein in the synthesis. Suitable zeolitic materials include those identified by the International Zeolite Association, including those with the identifiers ABW, ACO, AEI, AEL, AEN, AET, AFG, AFI, AFN, AFO, AFR, AFS, AFT, AFV, AFX, AFY, AHT, ANA, ANO, APC, APD, AST, ASV, ATN, ATO, ATS, ATT, ATV, AVE, AVL, AWO, AWW, BCT, BEC, BIK, BOF, BOG, BOZ, BPH, BRE, BSV, CAN, CAS, CDO, CFI, CGF, CGS, CHA, —CHI, -CLO, CON, CSV, CZP, DAC, DDR, DFO, DFT, DOH, DON, EAB, EDI, EEI, EMT, EON, EPI, ERI, ESV, ETL, ETR, ETV, EUO, EWO, EWS, EZT, FAR, FAU, FER, FRA, GIS, GIU, GME, GON, GOO, HEU, IFO, IFR, -IFT, —IFU, IFW, IFY, IHW, IMF, IRN, IRR, —IRY, ISV, ITE, ITG, ITH, ITR, ITT, -ITV, ITW, IWR, IWS, IWV, IWW, JBW, JNT, JOZ, JRY, JSN, JSR, JST, JSW, KFI, LAU, LEV, LIO, -LIT, LOS, LOV, LTA, LTF, LTJ, LTL, LTN, MAR, MAZ, MEI, MEL, MEP, MER, MFI, MFS, MON, MOR, MOZ, MRT, MSE, MSO, MTF, MTN, MTT, MTW, MVY, MWF, MWW, NAB, NAT, NES, NON, NPO, NPT, NSI, OBW, OFF, OKO, OSI, OSO, OWE, -PAR, PAU, PCR, PHI, PON, POR, POS, PSI, PTO, PTT, PTY, PUN, PWN, PWO, PWW, RHO, —RON, RRO, RSN, RTE, RTH, RUT, RWR, RWY, SAF, SAO, SAS, SAT, SAV, SBE, SBN, SBS, SBT, SEW, SFE, SFF, SFG, SFH, SFN, SFO, SFS, SFW, SGT, SIV, SOD, SOF, SOR, SOS, SOV, SSF, SSY, STF, STI, STT, STW, —SVR, SVV, SWY, -SYT, SZR, TER, THO, TOL, TON, TSC, TUN, UEI, UFI, UOS, UOV, UOZ, USI, UTL, UWY, VET, VFI, VNI, VSV, WEI, -WEN, YFI, YUG, ZON, *BEA, *CTH, *-EWT, *-ITN, *MRE, *PCS, *SFV, *—SSO, *STO, *—SVY, *UOE. In certain embodiments, zeolites synthesized herein comprise co-crystallized products of two or more types of zeolites identified above. Note that the three-letter codes designated herein correspond to the framework types established by the International Zeolite Association.

For example, certain non-limiting examples of zeolites known to be useful in the petroleum refining industry include but are not limited to those possessing MFI, FAU, *BEA, MOR, or CHA frameworks. In certain embodiments a zeolite synthesized can be MFI framework, which includes ZSM-5, having a micropore size related to the 10-member rings when viewed along the [100] and [010] directions of 5.5×5.1 Å and 5.6×5.3 Å, respectively. In certain embodiments a zeolite synthesized can be FAU framework, which includes USY, having a micropore size related to the 12-member ring when viewed along the [111] direction of 7.4×7.4 Å. In certain embodiments a zeolite synthesized can be *BEA framework, which includes zeolite beta polymorph A, having a micropore size related to the 12-member rings when viewed along the [100] and [001] directions of 6.6×6.7 Å and 5.6×5.6 Å, respectively. In certain embodiments a zeolite synthesized can be MOR framework, which includes mordenite zeolites, having a micropore size related to the 12-member ring and 8-member ring when viewed along the [001] and [001] directions of 6.5×7.0 Å and 2.6×5.7 Å, respectively. In certain embodiments a zeolite synthesized can be CHA framework zeolite, which includes chabazite zeolite, having a micropore size related to the 8-member ring when viewed normal to the [001] direction of 3.8×3.8 Å.

In an embodiment of a method of synthesizing zeolite, effective amounts and proportions of precursors and reagents are formed together with water-soluble ODSO as a homogeneous aqueous mixture, including a water source, an optional alumina source, a silica source, an alkali metal source, an optional structure directing agent and an optional seed material. An effective amount of a water-soluble ODSO component is used as an additional component in the syntheses processes herein. The water-soluble ODSO component can be in the form of a neat water-soluble ODSO, as an aqueous water-soluble ODSO solution, as a pH-modified ODSO, and/or a supernatant from a prior synthesis using water-soluble ODSO.

An effective amount of water-soluble ODSO is used as an additional component in zeolite synthesis. In certain embodiments the water-soluble ODSO composition is used in place of a certain amount of water. In certain embodiments the water-soluble ODSO is provided as a pH-modified water-soluble ODSO composition and is used in place of an equivalent amount (on a mass or volume basis) of a certain amount of utility water for the homogeneous aqueous mixture. In certain embodiments the water-soluble ODSO is provided as a pH-modified water-soluble ODSO composition and is used in place of all or a portion of requisite alkali metal or mineralizer for zeolite synthesis.

The components are mixed for an effective time and under conditions suitable to form the homogeneous aqueous mixture. The chronological sequence of mixing can vary, with the objective being a highly homogenous distribution of the components in an aqueous mixture. In certain embodiments, the homogeneous aqueous mixture is formed by: providing a silica source; combining an optional alumina source, an alkali metal source and an optional structure directing agent; and combining water soluble ODSO. Alternatively, the water soluble ODSO is combined with the optional alumina source, the alkali metal source and the optional structure directing agent, and that mixture is combined with the silica source. In certain embodiments, the homogeneous aqueous mixture is formed by: providing an optional alumina source, an alkali metal source and an optional structure directing agent as a mixture; combining a silica source; and combining a water soluble ODSO. Alternatively, the water soluble ODSO is combined with the silica source, and that mixture is combined with the optional alumina source, the alkali metal source and the optional structure directing agent. In certain embodiments, the homogeneous aqueous mixture is formed by: combining a water soluble ODSO with a silica source to form a mixture; and that mixture is combined with an optional alumina source, an alkali metal source and an optional structure directing agent. In certain embodiments, the homogeneous aqueous mixture is formed by: combining a water soluble ODSO with an optional alumina source, an alkali metal source and an optional structure directing agent to form a mixture; and that mixture is combined with a silica source.

A homogeneous aqueous mixture of the precursors and reagents, including water soluble ODSO, is formed from any of the above chronological sequences of component addition. The components are mixed for an effective time and under conditions suitable to form the homogeneous aqueous mixture. The homogeneous aqueous mixture is heated under conditions and for a time effective to form a precipitate (product) suspended in a supernatant (mother liquor). The precipitate is recovered, for example by filtration, washing and drying. In certain embodiments the recovered precipitate is calcined at a suitable temperature, temperature ramp rate and for a suitable period of time.

The eventual framework of the as-made zeolites depends on various factors including but not limited to the time and/or temperature of hydrothermal reaction; selected structure directing agents (if any); selected seeds; and/or selected mineralizer. In certain embodiments, inclusion of a water-soluble ODSO shifts a phase boundary of a sol-gel composition to a certain zeolite framework type having an equivalent amount of water being replaced, even using compositional ratios and conditions (other than the water-soluble ODSO) typically effective for synthesis of a different type of crystalline material, a different sub-type of zeolite, or that would typically produce amorphous material.

In the above embodiments in which a silica source is used, the silica source can comprise, without limitation, one or more of silicates including sodium silicate (water glass), rice husk, fumed silica, precipitated silica, colloidal silica, silica gels, other zeolites, dealuminated zeolites, and silicon hydroxides and alkoxides. Silica sources resulting in a high relative yield are preferred. For instance, suitable materials as silica sources include fumed silica commercially available from Cabot and colloidal silica (LUDOX commercially available from Cabot).

In the above embodiments in which an alumina source is used, the aluminum source can comprise, without limitation, one or more of aluminates, alumina, other zeolites, aluminum colloids, boehmites, pseudo-boehmites, aluminum salts such as aluminum nitrate, aluminum sulfate and alumina chloride, aluminum hydroxides and alkoxides, aluminum wire and alumina gels. For example, suitable materials as aluminum sources include commercially available materials including for instance high purity aluminas (CERALOX commercially available from Sasol) and alumina hydrates (PURAL and CAPITAL commercially available from Sasol), boehmites (DISPERSAL and DISPAL commercially available from Sasol), and silica-alumina hydrates (SIRAL commercially available from Sasol) and the corresponding oxides (SIRALOX commercially available from Sasol).

In the above embodiments in which a structure directing agent is used, the structure directing agent selected to influence the target type of zeolite structure to be formed. Effective structure directing agents that can optionally be added include known or developed structure directing agents for a particular type or sub-type of zeolite. Effective structure directing agents for zeolites include one or more of quaternary ammonium ions, trialkylamines, dialkylamines, monoalkylamines, cyclic amines, alkylethanol amines, cyclic diamines, alkyl diamines, alkyl polyamines, and other templates including alcohols, ketones, morpholine and glycerol. For example, in embodiments in which the target zeolite structures are MFI, including ZSM-5, beta zeolite, or mordenite zeolite, suitable structure directing agents include but are not limited to one or more of quaternary ammonium cation compounds (including one or more of tetramethylammonium (TMA) cation compounds, tetraethylammonium (TEA) cation compounds, tetrapropylammonium (TPA) cation compounds, tetrabutylammonium (TBA) cation compounds, cetyltrimethylammonium (CTA) cation compounds; the cation can be paired with one or more of a hydroxide anion (for example, TPAOH or CTAOH), a bromide anion (for example, TPAB or CTAB), or an iodide anion. In embodiments in which the target zeolite structures are MFI zeolites, including ZSM-5, structure directing agents include but are not limited to one or more of: those identified above for MFI zeolites; bifunctional dicationic molecules containing a long aliphatic chain (for example C₂₂H₄₅—N⁺(CH₃)₂—C₆H₁₂—N⁺(CH₃)₂—C₆H₁₃, denoted C₂₂₋₆₋₆, C₂₂H₄₅—N⁺(CH₃)₂—C₆H₁₂—N⁺(CH₃)₂—C₃H₇, denoted C₂₂₋₆₋₃, or a poly(ethylene glycol)); dual-porogenic surfactants; silylated polyethylenimine polymers; amphiphilic organosilanes; or hydrophilic cationic polyelectroyltes/polymers such as poly(diallyldimethylammonium chloride) (PDADMAC). In embodiments in which the target zeolite structures are beta zeolites, structure directing agents include but are not limited to one or more of: those identified above for beta zeolite; 4,4′trimethylene bis(N-methyl N-benzyl-piperidinium) hydroxide; 1,2-diazabicyclo 2,2,2, octane (DABCO); dialkylbenzyl ammonium hydroxide; dimethyldiisopropylammonium hydroxide (DMDPOH); N,N-dimethyl-2,6-cis-dimethylpiperdinium hydroxide (DMPOH); N-ethyl-N,N-dimethylcyclohexanaminium hydroxide (EDMCHOH); N,N,N-trimethylcyclohexanaminium hydroxide (TMCHOH); N-isopropyl-N-methyl-pyrrolidinium (iProOH); N-isobutyl-N-methyl-pyrrolidinium (iButOH); N-isopentyl-N-methyl-pyrrolidinium (iPenOH); or any of the thousands of structure directing agents for producing zeolite beta can be used, as disclosed in Daeyaerta et al., “Machine-learning approach to the design of OSDAs for zeolite beta,” PNAS February, 116 (2019): 3413-3418. In embodiments in which the target zeolite structures are mordenite zeolite, structure directing agents include but are not limited to one or more of: those identified above for mordenite zeolite; mixed organic templates such as glycerol, ethylene glycol or polyethylene glycol; pyrrolidine-based mesoporogens; piperazine; 1,6-diaminohexane; diethylpiperidinium; or co-operative organic templates such as N,N,N-trimethyl-1,1-adamantammonium and 1,2-hexanediol. In embodiments in which the target zeolite structures are (CHA) zeolite, structure directing agents include but are not limited to one or more of comprising quaternary ammonium cations derived from adamantamine such as N,N,N-trimethyl-1-adamantammonium, derived from quinuclidinol such as N-methyl-3-quinuclidinol and derived from cyclohexyl/cyclohexylmethyl such as trimethyl(cyclohexylmethyl)ammonium.

The disclosed process for synthesizing zeolite as disclosed herein can occur in the absence or presence of seed materials comprising zeolite structures of the same or similar crystalline framework structure as the target zeolite framework for production. For example: for MFI zeolites, suitable seed materials include ZSM-5 (MFI), ZSM-8 (MFI), ZSM-11 (MEL) and Silicalite-1 (MFI); for beta zeolites, other beta zeolites are used as seed materials; for mordenite zeolites, other mordenite zeolites are used as seed materials; for FAU zeolites, suitable seed materials are zeolite Y, zeolite X, USY zeolite, faujasite zeolite or small protozeolitic species (gels). Functions of the seeds can include, but are not limited to: supporting growth on the surface of the seed, that is, where crystallization does not undergo nucleation but rather crystal growth is directly on the surface of the seed; the parent gel and seed share common larger composite building units; the parent gel and seed share common smaller units, for instance 4 member rings; seeds that undergo partial dissolution to provide a surface for crystal growth of a zeolite; crystallization occurs through a “core-shell” mechanism with the seed acting as a core and the target material grows on the surface; and/or where the seeds partially dissolve providing essential building units that can orientate crystallization of the zeolite or other crystalline structure.

In the above embodiments in which a mineralizer is necessary, a hydroxide mineralizer is included as the hydroxide derived from the alkali metal source from the Periodic Table IUPAC Group 1 alkaline metals (and/or from the hydroxide of any hydroxide-containing structure directing agent). For example, these are selected from the group consisting of NaOH, KOH, RbOH, LiGH, CsOH and combinations thereof. In certain embodiments a Na-based hydroxide mineralizer is selected.

The mixing steps typically occur at ambient temperature and pressure (for instance about 20° C. and about 1 standard atmosphere), for a time is sufficient to realize a homogeneous distribution of the components. In certain embodiments the sol-gel can be aged before being subjected to subsequent hydrothermal treatment, for example for a period of about 0-72, 0-48, 0-24, 0-6, 0.5-72, 0.5-48, 0.5-24, 6-72, 6-48 or 6-24 hours. Hydrothermal treatment is then carried out at a temperature in the range of about 90-220, 100-200, 100-180, 100-160, 100-220, 100-200, 100-180, 100-160, 120-220, 120-200, 120-180, 120-160, 140-220 or 140-200° C. and at atmospheric or autogenous pressure, or at a pressure in the range of from atmospheric pressure to 17 bar (from the sol-gel or from the sol-gel plus an addition of a gas purge into the vessel prior to heating), and for a time period within the range of about 0.1-14, 0.2-14, 0.1-12, 0.2-12, 0.1-10, 0.2-10, 0.1-7, 0.2-7, 0.1-6, 0.2-6, 0.1-5 or 0.2-5 days, to ensure crystallization and formation of a zeolite gel. As is known, these time periods and temperatures can vary depending on the desired zeolite or other crystalline material framework to be produced.

The products are washed, for example with water at a suitable quantity, for example at about twice the volume of the sol-gel solution. The wash can be at a temperature of from about 20-80° C. at atmospheric, vacuum or under pressure. The wash can continue until the pH of the filtrate approaches about 5-9, 5-7, or 7-9. The solids are recovered by filtration, for instance, using known techniques such as centrifugation, gravity, vacuum filtration, filter press, or rotary drums, and dried, for example at a temperature of up to about 110 or 150° C.

In certain embodiments, recovered precipitate is calcined at a suitable temperature, temperature ramp rate and for a suitable period of time. In certain embodiments, calcining is carried out to increase porosity. In certain embodiments, calcining is carried out to remove all or a portion of structure directing agent components that remain in the precipitate to realize porous zeolite. In optional embodiments in which calcination is carried out on zeolite produced, conditions for calcination can include temperatures in the range of about 350-1000, 350-700, 350-685, 350-650, 450-1000, 450-700, 450-685, 450-650, 500-1000, 500-700, 500-685 or 500-650° C., atmospheric pressure, and a time period of about 3-24, 3-18, 6-24 or 6-18 hours. Calcining can occur with ramp rates in the range of from about 0.1-10, 0.1-5, 0.1-3, 1-10, 1-5 or 1-3° C. per minute. In certain embodiments calcination can have a first step ramping to a temperature of between about 100-150° C. with a holding time of from about 2-24 hours (at ramp rates of from about 0.1-5, 0.1-3, 1-5 or 1-3° C. per min) before increasing to a higher temperature with a final holding time in the range of about 2-24 hours.

It is to be appreciated by those skilled in the art that in certain embodiments effective baseline compositional ratios for synthesis of zeolite as disclosed herein can be determined by empirical data, for instance summarized as phase boundary diagrams or other methodologies as is known in material synthesis. In certain embodiments, baseline compositional ratios and conditions are effective, in the absence of water soluble ODSO, for synthesis one type or sub-type of zeolite, and according to certain embodiments of the process herein, inclusion of water soluble ODSO results in shifting the material type out of the phase boundary diagram, even at approximately equivalent ratios, to a different type or sub-type of crystalline material, or an amorphous material.

In some embodiments, effective ratios of precursors and reagents for production of zeolites herein are within those known to produce templated aluminosilicate zeolites and can be determined by those of ordinary skill in the art. For example, effective amounts of silica and alumina precursors are provided to produce synthesized zeolite having a silica-to-alumina ratio (SAR) in the range of about 2-10000, 2-5000, 2-500, 2-100, 2-80, 10-10000, 10-5000, 10-500, 10-100, 10-80, 50-10000, 50-5000, 50-1000, 50-500 or 50-100. The SAR levels in the synthesized zeolite depends on the type of zeolite; for instance: MFI zeolites including ZSM-5 have effective SAR (mol/mol) values in the synthesized zeolite in the range of about 20-1500, 20-1000, 20-500, 25-1500, 25-1000, 25-500, 50-1500, 50-1000, 50-500, 100-1500, 100-1000 or 100-500; *BEA zeolites and/or MOR zeolites have effective SAR (mol/mol) values in the synthesized zeolite of greater than 10, in certain embodiments in the range of about 10-10000, 10-5000, 10-500, 10-100, 10-80, 50-10000, 50-5000, 50-1000, 50-500 or 50-100; zeolite Y has effective SAR (mol/mol) values in the synthesized zeolite in the range of about 3-6. In embodiments in which a structure directing agent is used, an effective amount includes a molar ratio (normalized to 1 mole of Al₂O₃) in the range of about 0.1-75, 0.1-50, 0.1-30, 0.1-20, 0.1-15, 1-75, 1-50, 1-30, 1-20, 1-15, 2.5-75, 2.5-50, 2.5-30, 5-75, 5-50 or 5-30.

In certain embodiments, baseline compositional ratios of the aqueous composition used to produce zeolites herein include (on a molar basis): SiO₂/Al₂O₃ of about 1-1500; OH⁻/SiO₂ of about 0.05-3; R/SiO₂ of about 0-1.5; alkali metal cation/SiO₂ of about 0.075-3.0; and H₂O/SiO₂ of about 5-120; wherein R is the structure directing agent, and a level of 0 represents absence of the structure directing agent. It is appreciated by those skilled in the art that these molar composition ratios can be expressed on a mass basis.

As is known, different ratios of materials are used depending on the desired zeolite to be produced. In the embodiments herein, ratios of components in homogeneous aqueous mixtures including water soluble ODSO are sometimes referred to as “water soluble ODSO-enhanced compositional ratios.” In certain embodiments a water soluble ODSO-enhanced compositional ratio is one in which water soluble ODSO is included to replace an approximately equivalent mass of a certain amount of water in the homogeneous aqueous mixture, and wherein a cumulative amount of water soluble ODSO and water (water soluble ODSO+H₂O) is approximately equivalent to a mass of water that is effective to produce the same or another type of zeolite, or an amorphous material, in the absence of water soluble ODSO. In certain embodiments: a baseline compositional ratio of silica, optional aluminum, alkali metal, optional structure directing agent, optional seed and water is known or determined to be is effective to produce the same or another type of zeolite, or an amorphous material, in the absence of water soluble ODSO; a water soluble ODSO-enhanced compositional ratio is approximately equivalent to the baseline compositional ratio except for the substitution of water soluble ODSO for water on a mass basis; and wherein the conditions and time of heating the sol-gel having the water soluble ODSO-enhanced compositional ratio is approximately equivalent to those that are effective to produce the same or another type of zeolite, or an amorphous material, in the absence of water soluble ODSO.

The present disclosure includes one or more water-soluble ODSO compounds including ODSO compounds that are used as a component in a material synthesis process, wherein the supernatant contains one or more ODSO components. The additional components can be a mixture that comprises two or more ODSO compounds. In the description herein, the terms “oxidized disulfide oil”, “ODSO”, “ODSO mixture” and “ODSO compound(s)” may be used interchangeably for convenience. As used herein, the abbreviations of oxidized disulfide oils (“ODSO”) and disulfide oils (“DSO”) will be understood to refer to the singular and plural forms, which may also appear as “DSO compounds” and “ODSO compounds,” and each form may be used interchangeably. In certain instances, a singular ODSO compound may also be referenced.

As disclosed herein, in certain embodiments a water-soluble ODSO component includes a pH-modified water-soluble ODSO composition can be used. The pH-modified water-soluble ODSO composition comprises an acidic water-soluble ODSO composition and an alkaline agent. In certain embodiments, the pH-modified WS-ODSO composition provides a portion of requisite water to form the aqueous mixture. In certain embodiments, the pH-modified WS-ODSO composition provides sufficient water to avoid added utility water. In certain embodiments, the pH-modified WS-ODSO composition provides a portion of requisite alkali metal or mineralizer to homogeneous aqueous mixture to produce zeolite. In certain embodiments, the alkaline agent is selected from the group consisting of sodium hydroxide, calcium hydroxide, lithium hydroxide, strontium hydroxide, barium hydroxide, potassium hydroxide, cesium hydroxide, rubidium hydroxide, ammonia, ammonium hydroxide, lithium hydroxide, zinc hydroxide, trimethylamine, pyridine, beryllium hydroxide, magnesium hydroxide, and combinations of one of the foregoing alkaline agents. In certain embodiments, the alkaline agent is selected from the group consisting of sodium hydroxide, potassium hydroxide, rubidium hydroxide, lithium hydroxide, cesium hydroxide, and combinations of one of the foregoing alkaline agents.

As disclosed herein, in certain embodiments a water-soluble ODSO component includes supernatant from a prior synthesis that utilized water-soluble ODSO. In such a process, a first synthesis of a first material is carried out using water soluble ODSO as a component (as-is, or as a pH modified composition). All or a portion of a precipitate is separated from a supernatant, and that supernatant from an ODSO synthesis is used as a water-soluble ODSO component herein. In certain embodiments, the supernatant from an ODSO-enhanced synthesis provides a portion of requisite water to form the aqueous mixture. In certain embodiments, the supernatant from an ODSO-enhanced synthesis provides sufficient water to avoid added utility water. In certain embodiments, the supernatant from an ODSO-enhanced synthesis provides a portion of requisite alkali metal or mineralizer to homogeneous aqueous mixture to produce zeolite.

Note that the alkali metal source in the overall sol-gel is provided as a hydroxide, but in embodiments herein where the ratio is expressed based on the mass of the alkali, it may be expressed based on the metal itself. In embodiments where a pH-modified WS-ODSO is used, the mineralizer is present in form of cation, and ODSO as anion. For instance, when the alkali is NaOH, the ODSO/Na ratio is determined by dividing the mass of the ODSO by the mass of the Na portion of NaOH, that is, about 57.5% of the NaOH mass. In certain embodiments, the effective amount of ODSO is that which results in the synthesis of zeolite is an ODSO/Na ratio (wt./wt.) in the range of about 0.01-11, 0.01-10, 0.01-9, 0.01-8, 0.01-7, 0.01-6, 0.01-5, 0.01-4, 0.01-3, 0.01-2, 0.01-1, 0.01-0.1, 0.1-11, 0.1-10, 0.1-9, 0.1-8, 0.1-7, 0.1-6, 0.1-5, 0.1-4, 0.1-3, 0.1-2, 0.1-1, 1-11, 1-10, 1-9, 1-8, 1-7, 1-6, 1-5, 1-4, 1-3, 1-2,2-11,2-10,2-9,2-8,2-7,2-6,2-5,2-4 or2-3.

In certain embodiments, the alkali metal source is sodium, the zeolite is ZSM-5 zeolite and the effective amount of ODSO is that which results in the synthesis of zeolite is an ODSO/Na ratio (wt./wt.) in the range of about 0.1-10, 0.1-8.5, 0.1-7, 1-10, 1-8.5, 1-7, 2-10, 2-8.5, or 2-7.

In certain embodiments, the alkali metal source sodium, the zeolite is *BEA zeolite and the effective amount of ODSO is that which results in the synthesis of zeolite is an ODSO/Na ratio (wt./wt.) in the range of about 0.1-10, 0.1-5, 0.1-3, 0.1-1, 0.5-10, 0.5-5, 0.5-3, 0.5-1, 1-10, 1-5, or 1-3.

In certain embodiments, the alkali metal source sodium, the zeolite is FAU zeolite and the effective amount of ODSO is that which results in the synthesis of zeolite is an ODSO/Na ratio (wt./wt.) in the range of about 0.1-2.7, 0.1-2.5, 0.1-2, 0.1-1, 0.5-2.7, 0.5-2.5, 0.5-2, 0.5-1, 1-2.7, 1-2.5, or 1-2.

It is noted that various factors can contribute to quantity of ODSO, including the type of zeolite formed, the ratios of other components, and the amount of alkali metal. In certain embodiments the basic components from all of the sources are provided in effective amounts so as to maintain the homogeneous mixture at a pH level of greater than or equal to about 9, for example in the range of about 9-14, 9-13, 10-14, 10-13, 11-14 or 11-13. It is appreciated that the overall pH is influenced by anions from the ODSO component and any added alkali metal, and in certain embodiments, an alkali metal source, and in certain embodiments, an optional mineralizer source, and in certain embodiments anions from other sources such as from an alumina source or a silica source. In certain embodiments hydroxide anions are provided from a mineralizer from an alkali metal source, a structure directing agent, or both a mineralizer from an alkali metal source and a structure directing agent. In the process herein, the pH is reduced by the presence of ODSO, therefore, the quantity of the basic compound from one or more of the aforementioned sources can be adjusted accordingly to attain the requisite pH.

In certain embodiments, the one or more ODSO compounds are contained in a mixture with one or more catalytically active components and ODSO, as an active component carrier composition (as disclosed in co-pending and commonly owned U.S. application Ser. No. 17/720,434 filed Apr. 14, 2022, entitled “Active Component Carrier Composition, and Method for Manufacture of Catalyst Materials,” which is incorporated by reference herein in its entirety). One or more catalytically active components are included in a mixture with one or more ODSO compounds. The one or more active components can vary, depending upon the application of the catalyst being manufactured. The active component can be a metal or a non-metal, in elemental form or as a compound such as oxides, carbides or sulfides. For instance, one or more active components for hydrotreating catalysts can include one or more metals or metal compounds selected from the Periodic Table of the Elements IUPAC Groups 4-12. In certain embodiments one or more active components are selected for producing hydrotreating catalysts and can include one or more metals or metal compounds selected from the Periodic Table of the Elements IUPAC Groups 6-10 (for example Co, Ni, Mo, and combinations thereof). In certain embodiments one or more active components are selected for producing hydrocracking catalysts and can include one or more metals or metal compounds selected from the Periodic Table of the Elements IUPAC Groups 6-10 (for example Co, Ni, W, Mo, and combinations thereof). In certain embodiments one or more active components are selected for producing catalytic reforming catalysts and can include one or more metals or metal compounds selected from the Periodic Table of the Elements IUPAC Groups 8-10 (for example Pt or Pd). In certain embodiments one or more active components are selected for producing hydrogenation catalysts and can include one or more metals or metal compounds selected from the Periodic Table of the Elements IUPAC Groups 7-10 (for example Pt or Pd), and/or one or more non-metal compound such as P. In certain embodiments one or more active components are selected for producing oxidation catalysts and can include one or more metals or metal compounds selected from the Periodic Table of the Elements IUPAC Groups 4-10 (for example Ti, V, Mn, Co, Fe, Cr and Mo) or from the Periodic Table of the Elements IUPAC Groups 4-12 (for example Ti, V, Mn, Co, Fe, Cr, Cu, Zn, W, Mo).

In certain embodiments, the produced aqueous liquid mixture comprises one or more ODSO compounds that are contained in reaction products, or a fraction of reaction products, derived from controlled catalytic oxidation of disulfide oil compounds in the presence of an oxidation catalyst containing one or more transition metals. For example, as described above and in commonly owned U.S. Pat. No. 10,807,947 which is incorporated by reference herein in its entirety, a controlled catalytic oxidation of MEROX process by-products DSO can be carried out. The resulting oxidized effluents contain ODSO. As disclosed in 10,807,947, the by-product DSO compounds from the mercaptan oxidation process can be oxidized, typically in the presence of a catalyst. The oxidant can be a liquid peroxide selected from the group consisting of alkyl hydroperoxides, aryl hydroperoxides, dialkyl peroxides, diaryl peroxides, peresters and hydrogen peroxide. The oxidant can also be a gas, including air, oxygen, ozone and oxides of nitrogen. In embodiments herein, a catalyst is used in the oxidation process. The oxidation catalyst can contain one active metals from IUPAC Groups 4-10 or from Groups 4-12 of the Periodic Table. In certain embodiments oxidation catalyst are metals or metal compounds containing one or more transition metals. In certain embodiments oxidation catalyst are metals or metal compounds containing one or more metals selected from the group consisting of Ti, V, Mn, Co, Fe, Cr, Cu, Zn, W, Mo and combinations thereof. In certain embodiments oxidation catalyst are compounds containing one or more metals or metal compounds selected from the group consisting of Mo, W, V, Ti, and combinations thereof. In certain embodiments oxidation catalyst are compounds containing one or more metals or metal compounds selected from the group consisting of Mo (VI), W (VI), V (V), Ti (IV), and combinations thereof. In certain embodiments, suitable homogeneous catalysts include molybdenum acetylacetonate, bis(acetylacetonate) dioxomolybdenum, molybdenum naphthenate, molybdenum hexacarbonyl, tungsten hexacarbonyl, sodium tungstate and vanadium pentoxide. In certain embodiments, a suitable catalyst is sodium tungstate, Na₂WO₄·2H₂O.

In certain embodiments ODSO is obtained from controlled catalytic oxidation of disulfide oils from mercaptan oxidation processes. The effluents from controlled catalytic oxidation of disulfide oils from mercaptan oxidation processes includes ODSO compounds and in certain embodiments DSO compounds that were unconverted in the oxidation process. In certain embodiments this effluent contains water-soluble compounds and water-insoluble compounds. The effluent contains at least one ODSO compound, or a mixture of two or more ODSO compounds, selected from the group consisting of compounds having the general formula (R—SO—S—R′), (R—SOO—S—R′), (R—SOO—SO—R′), (R—SOO—SOO—R′), (R—SO—SO—R′), (R—SO—SOO—OH), (R—SOO—SOO—OH), (R—SO—SO—OH), (R—SOO—SO—OH), (R′—SO—SO—OR), (R′—SOO—SO—OR), (R′—SO—SOO—OR) and (R′—SOO—SOO—OR). In certain embodiments, in the above formulae R and R′ can be the same or different C1-C10 alkyl or C6-C10 aryl. It will be understood that since the source of the DSO is a refinery feedstream, the R and R′ substituents vary, such as methyl and ethyl subgroups, and the number of sulfur atoms, S, in the as-received feedstream to oxidation can extend to 3, for example, trisulfide compounds.

In embodiments herein the water-soluble compounds and water-insoluble compounds are separated from one another, and the ODSO used herein comprises all or a portion of the water-soluble compounds separated from the total effluents from oxidation of disulfide oils from mercaptan oxidation processes. For example, the different phases can be separated by decantation or partitioning with a separating funnel, separation drum, by decantation, or any other known apparatus or process for separating two immiscible phases from one another. In certain embodiments, the water-soluble and water-insoluble components can be separated by distillation as they have different boiling point ranges. It is understood that there will be crossover of the water-soluble and water-insoluble components in each fraction due to solubility of components, typically in the ppmw range (for instance, about 1-10,000, 1-1,000, 1-500 or 1-200 ppmw). In certain embodiments, contaminants from each phase can be removed, for example by stripping or adsorption.

In certain embodiments ODSO used herein comprises, consists of or consists essentially of at least one ODSO compound having 3 or more oxygen atoms that is selected from the group consisting of compounds having the general formula (R—SOO—SO—R′), (R—SOO—SOO—R′), (R—SO—SOO—OH), (R—SOO—SOO—OH), (R—SOO—SO—OH), (R—SO—SO—OR′), (R—SOO—SO—OR′), (R—SO—SOO—OR′) and (R—SOO—SOO—OR′). In certain embodiments ODSO used herein comprises, consists of or consists essentially of a mixture of two or more ODSO compounds having 3 or more oxygen atoms, that is selected from the group consisting of compounds having the general formula (R—SOO—SO—R′), (R—SOO—SOO—R′), (R—SO—SOO—OH), (R—SOO—SOO—OH), (R—SOO—SO—OH), (R—SO—SO—OR′), (R—SOO—SO—OR′), (R—SO—SOO—OR′) and (R—SOO—SOO—OR′). In certain embodiments ODSO used herein comprises, consists of or consists essentially of ODSO compounds selected from the group consisting of (R—SOO—SO—R′), (R—SOO—SOO—R′), (R—SO—SOO—OH), (R—SOO—SOO—OH), (R—SO—SO—OH), (R—SOO—SO—OH), and mixtures thereof. In certain embodiments, in the above formulae R and R′ can be the same or different C1-C10 alkyl or C6-C10 aryl. In certain embodiments, the R and R′ are methyl and/or ethyl groups. In certain embodiments, the WS-ODSO compound(s) used herein have 1 to 20 carbon atoms.

In some embodiments, the ODSO compounds used as a component for zeolite synthesis are derived from oxidized DSO compounds present in an effluent refinery hydrocarbon stream recovered following the catalytic oxidation of mercaptans present in the hydrocarbon stream. In some embodiments, the DSO compounds are oxidized in the presence of a catalyst. The effluent hydrocarbon stream recovered following the catalytic oxidation of DSO, derived from the catalytic oxidation of mercaptans present in a mercaptan-containing hydrocarbon stream, generally comprises a mixture of ODSO compounds described herein and sulfur compounds including sulfonic acids, for example, methane sulfonic acid, ethane sulfonic acid, or an alkyl sulfonic acid (the alkyl group being based on the R group of the DSO being oxidized).

In certain embodiments, the ODSO compounds used herein comprise, consist of or consist essentially of ODSO compounds having an average density greater than about 1.0 g/cc. In certain embodiments, the ODSO compounds used herein comprise, consist of or consist essentially of ODSO compounds having an average boiling point greater than about 80° C. In certain embodiments, the ODSO compounds used herein comprise, consist of or consist essentially of ODSO compounds having a dielectric constant that is less than or equal to 100 at 0° C.

Table 4 includes examples of polar ODSO compounds that contain 3 or more oxygen atoms. In certain embodiments the identified ODSO compounds are obtained from a water-soluble fraction of the effluents from oxidation of DSO obtained from MEROX by-products. The ODSO compounds that contain 3 or more oxygen atoms are water-soluble over effectively all concentrations, for instance, with some minor amount of acceptable tolerance for carry over components from the effluent stream and in the water insoluble fraction with 2 oxygen atoms of no more than about 1, 3 or 5 mass percent.

In certain embodiments the ODSO compounds contained in an oxidation effluent stream that is derived from controlled catalytic oxidation of MEROX process by-products, DSO compounds, as disclosed in U.S. Pat. Nos. 10,807,947 and 10,781,168 and as incorporated herein by reference above.

In some embodiments, the ODSO are derived from oxidized DSO compounds present in an effluent refinery hydrocarbon stream recovered following the catalytic oxidation of mercaptans present in the hydrocarbon stream. In some embodiments, the DSO compounds are oxidized in the presence of a catalyst.

As noted above, the designation “MEROX” originates from the function of the process itself, that is, the conversion of mercaptans by oxidation. The MEROX process in all of its applications is based on the ability of an organometallic catalyst in a basic environment, such as a caustic, to accelerate the oxidation of mercaptans to disulfides at near ambient temperatures and pressures. The overall reaction can be expressed as follows:

RSH+¼O₂—>½RSSR+½H₂O (1)

where R is a hydrocarbon chain that may be straight, branched, or cyclic, and the chains can be saturated or unsaturated. In most petroleum fractions, there will be a mixture of mercaptans so that the R can have 1, 2, 3 and up to 10 or more carbon atoms in the chain. This variable chain length and type is indicated by R and R′ in the reaction. The reaction is then written:

2R′SH+2RSH+O₂->2R′SSR+2H₂O (2)

This reaction occurs spontaneously whenever any sour mercaptan-bearing distillate is exposed to atmospheric oxygen, but proceeds at a very slow rate. In addition, the catalyzed reaction (1) set forth above requires the presence of an alkali caustic solution, such as aqueous sodium hydroxide. The mercaptan oxidation proceeds at an economically practical rate at moderate refinery downstream temperatures.

The MEROX process can be conducted on both liquid streams and on combined gaseous and liquid streams. In the case of liquid streams, the mercaptans are converted directly to disulfides which remain in the product so that there is no reduction in total sulfur content of the effluent stream. The MEROX process typically utilizes a fixed bed reactor system for liquid streams and is normally employed with charge stocks having end points above 135° C.-150° C. Mercaptans are converted to disulfides in the fixed bed reactor system over a catalyst, for example, an activated charcoal impregnated with the MEROX reagent, and wetted with caustic solution. Air is injected into the hydrocarbon feedstream ahead of the reactor and in passing through the catalyst-impregnated bed, the mercaptans in the feed are oxidized to disulfides. The disulfides are substantially insoluble in the caustic and remain in the hydrocarbon phase. Post treatment is required to remove undesirable by-products resulting from known side reactions such as the neutralization of H₂S, the oxidation of phenolic compounds, entrained caustic, and others.

The vapor pressures of disulfides are relatively low compared to those of mercaptans, so that their presence is much less objectionable from the standpoint of odor; however, they are not environmentally acceptable due to their sulfur content and their disposal can be problematical.

In the case of mixed gas and liquid streams, extraction is applied to both phases of the hydrocarbon streams. The degree of completeness of the mercaptan extraction depends upon the solubility of the mercaptans in the alkaline solution, which is a function of the molecular weight of the individual mercaptans, the extent of the branching of the mercaptan molecules, the concentration of the caustic soda and the temperature of the system. Thereafter, the resulting DSO compounds are separated, and the caustic solution is regenerated by oxidation with air in the presence of the catalyst and reused.

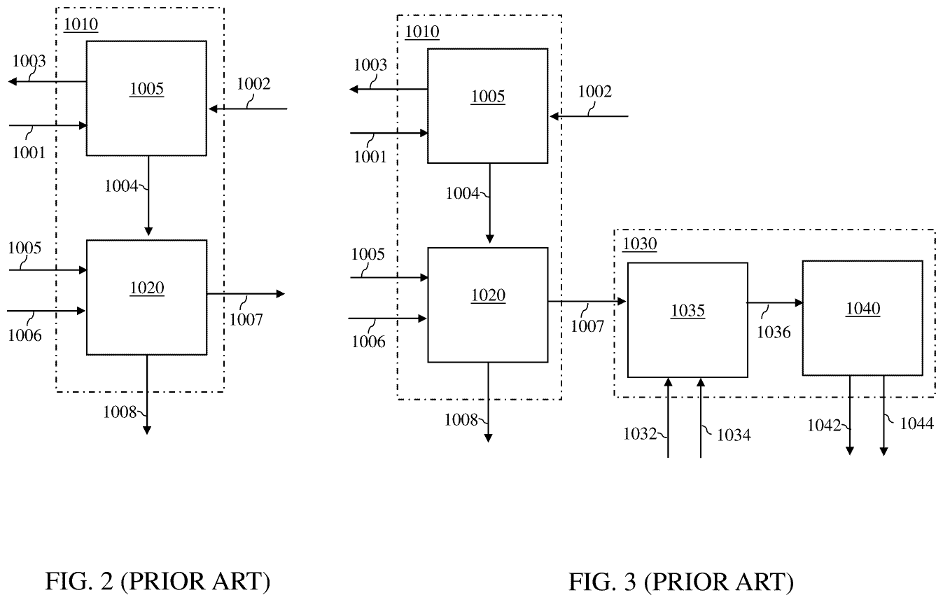

Referring to the attached drawings, FIG. 2 is a simplified schematic of a generalized version of a conventional MEROX process employing liquid-liquid extraction for removing sulfur compounds. A MEROX unit 1010, is provided for treating a mercaptan containing hydrocarbon stream 1001. In some embodiments, the mercaptan containing hydrocarbon stream 1001 is LPG, propane, butane, light naphtha, kerosene, jet fuel, or a mixture thereof. The process generally includes the steps of: introducing the hydrocarbon stream 1001 with a homogeneous catalyst into an extraction vessel 1005 containing a caustic solution 1002, in some embodiments, the catalyst is a homogeneous cobalt-based catalyst; passing the hydrocarbon catalyst stream in counter-current flow through the extraction section of the extraction 1005 vessel in which the extraction section includes one or more liquid-liquid contacting extraction decks or trays (not shown) for the catalyzed reaction with the circulating caustic solution to convert the mercaptans to water-soluble alkali metal alkane thiolate compounds; withdrawing a hydrocarbon product stream 1003 that is free or substantially free of mercaptans from the extraction vessel 1005, for instance, having no more than about 1000, 100, 10 or 1 ppmw mercaptans; recovering a combined spent caustic and alkali metal alkane thiolate stream 1004 from the extraction vessel 1005; subjecting the spent caustic and alkali metal alkane thiolate stream 1004 to catalyzed wet air oxidation in a reactor 1020 into which is introduced catalyst 1005 and air 1006 to provide the regenerated spent caustic 1008 and convert the alkali metal alkane thiolate compounds to disulfide oils; and recovering a by-product stream 1007 of DSO compounds and a minor proportion of other sulfides such as mono-sulfides and tri-sulfides. The effluents of the wet air oxidation step in the MEROX process can comprise a minor proportion of sulfides and a major proportion of disulfide oils. As is known to those skilled in the art, the composition of this effluent stream depends on the effectiveness of the MEROX process, and sulfides are assumed to be carried-over material. A variety of catalysts have been developed for the commercial practice of the process. The efficiency of the MEROX process is also a function of the amount of H₂S present in the stream. It is a common refinery practice to install a prewashing step for H₂S removal.

An enhanced MEROX process (“E-MEROX”) is a modified MEROX process where an additional step is added, in which DSO compounds are oxidized with an oxidant in the presence of a catalyst to produce a mixture of ODSO compounds. The by-product DSO compounds from the mercaptan oxidation process are oxidized, in some embodiments in the presence of a catalyst, and constitute an abundant source of ODSO compounds that are sulfoxides, sulfonates, sulfinates, sulfones and their corresponding di-sulfur mixtures. The disulfide oils having the general formula RSSR′ (wherein R and R′ can be the same or different and can have 1, 2, 3 and up to 10 or more carbon atoms) can be oxidized without a catalyst or in the presence of one or more catalysts to produce a mixture of ODSO compounds. The oxidant can be a liquid peroxide selected from the group consisting of alkyl hydroperoxides, aryl hydroperoxides, dialkyl peroxides, diaryl peroxides, peresters and hydrogen peroxide. The oxidant can also be a gas, including air, oxygen, ozone and oxides of nitrogen. If a catalyst is used in the oxidation of the disulfide oils having the general formula RSSR′ to produce the ODSO compounds, it can be a heterogeneous or homogeneous oxidation catalyst. The oxidation catalyst can be selected from one or more heterogeneous or homogeneous catalyst comprising metals from the IUPAC Group 4-12 of the Periodic Table, including Ti, V, Mn, Co, Fe, Cr, Cu, Zn, W and Mo. The catalyst can be a homogeneous water-soluble compound that is a transition metal containing an active species selected from the group consisting of Mo (VI), W (VI), V (V), Ti (IV), and combinations thereof. In certain embodiments, suitable homogeneous catalysts include molybdenum naphthenate, sodium tungstate, molybdenum hexacarbonyl, tungsten hexacarbonyl, sodium tungstate and vanadium pentoxide. An exemplary catalyst for the controlled catalytic oxidation of MEROX process by-products DSO is sodium tungstate, Na₂WO₄·2H₂O. In certain embodiments, suitable heterogeneous catalysts include Ti, V, Mn, Co, Fe, Cr, W, Mo, and combinations thereof deposited on a support such as alumina, silica-alumina, silica, natural zeolites, synthetic zeolites, and combinations comprising one or more of the above supports.

The oxidation of DSO typically is carried out in an oxidation vessel selected from one or more of a fixed-bed reactor, an ebullated bed reactor, a slurry bed reactor, a moving bed reactor, a continuous stirred tank reactor, and a tubular reactor. The ODSO compounds produced in the E-MEROX process generally comprise two phases: a water-soluble phase and water-insoluble phase, and can be separated into the aqueous phase containing water-soluble ODSO compounds and a non-aqueous phase containing water-insoluble ODSO compounds. The E-MEROX process can be tuned depending on the desired ratio of water-soluble to water-insoluble compounds presented in the product ODSO mixture. Partial oxidation of DSO compounds results in a higher relative amount of water-insoluble ODSO compounds present in the ODSO product and a near or almost complete oxidation of DSO compounds results in a higher relative amount of water-soluble ODSO present in the ODSO product. Details of the ODSO compositions are discussed in the U.S. Pat. No. 10,781,168, which is incorporated herein by reference above.

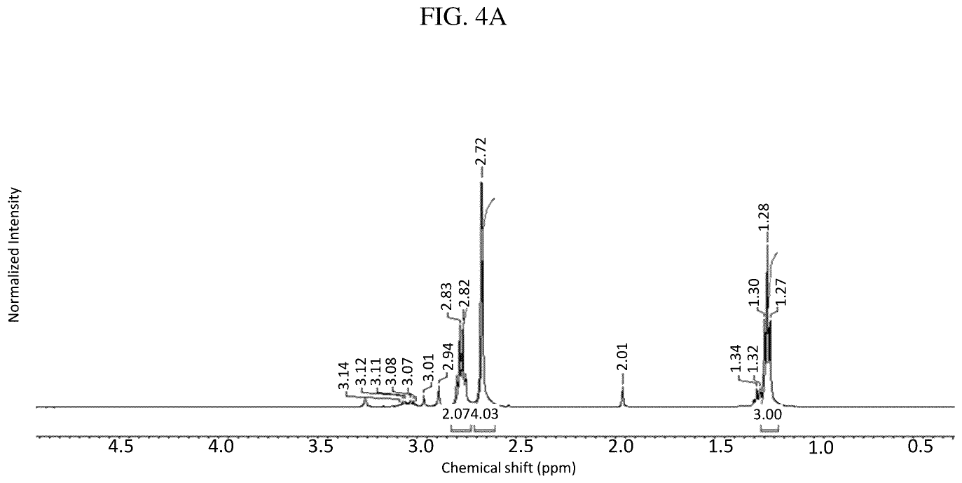

FIG. 3 is a simplified schematic of an E-MEROX process that includes E-MEROX unit 1030. The MEROX unit 1010 unit operates similarly as in FIG. 2, with similar references numbers representing similar units/feeds. In FIG. 3, the effluent stream 1007 from the generalized MEROX unit of FIG. 2 is treated. It will be understood that the processing of the mercaptan containing hydrocarbon stream of FIG. 3 is illustrative only and that separate streams of the products, and combined or separate streams of other mixed and longer chain products can be the subject of the process for the recovery and oxidation of DSO to produce ODSO compounds, that is the E-MEROX process. In order to practice the E-MEROX process, apparatus are added to recover the by-product DSO compounds from the MEROX process. In addition, a suitable reactor 1035 add into which the DSO compounds are introduced in the presence of a catalyst 1032 and an oxidant 1034 and subjecting the DSO compounds to a catalytic oxidation step to produce the mixed stream 1036 of water and ODSO compounds. A separation vessel 1040 is provided to separate the by-product 1044 from the ODSO compounds 1042.

The oxidation to produce OSDO can be carried out in a suitable oxidation reaction vessel operating at a pressure in the range from about 1-30, 1-10 or 1-3 bars. The oxidation to produce OSDO can be carried out at a temperature in the range from about 20-300, 20-150, 20-90, 45-300, 15-150 or 45-90° C. The molar feed ratio of oxidizing agent-to-mono-sulfur can be in the range of from about 1:1 to 100:1, 1:1 to 30:1 or 1:1 to 4:1. The residence time in the reaction vessel can be in the range of from about 5-180, 5-90, 5-30, 15-180, 15-90 or 5-30 minutes. In certain embodiments, oxidation of DSO is carried out in an environment without added water as a reagent. The by-products stream 1044 generally comprises wastewater when hydrogen peroxide is used as the oxidant. Alternatively, when other organic peroxides are used as the oxidant, the by-products stream 1044 generally comprises the alcohol of the peroxide used. For example, if butyl peroxide is used as the oxidant, the by-product alcohol 1044 is butanol.

In certain embodiments water-soluble ODSO compounds are passed to a fractionation zone (not shown) for recovery following their separation from the wastewater fraction. The fractionation zone can include a distillation unit. In certain embodiments, the distillation unit can be a flash distillation unit with no theoretical plates in order to obtain distillation cuts with larger overlaps with each other or, alternatively, on other embodiments, the distillation unit can be a flash distillation unit with at least 15 theoretical plates in order to have effective separation between cuts. In certain embodiments, the distillation unit can operate at atmospheric pressure and at a temperature in the range of from 100° C. to 225° C. In other embodiments, the fractionation can be carried out continuously under vacuum conditions. In those embodiments, fractionation occurs at reduced pressures and at their respective boiling temperatures. For example, at 350 mbar and 10 mbar, the temperature ranges are from 80° C. to 194° C. and 11° C. to 98° C., respectively. Following fractionation, the wastewater is sent to the wastewater pool (not shown) for conventional treatment prior to its disposal. The wastewater by-product fraction can contain a small amount of water-insoluble ODSO compounds, for example, in the range of from 1 to 10,000 ppmw. The wastewater by-product fraction can contain a small amount of water-soluble ODSO compounds, for example, in the range of from 1 to 50,000, or 100 to 50,000 ppmw. In embodiments where alcohol is the by-product alcohol, the alcohol can be recovered and sold as a commodity product or added to fuels like gasoline. The alcohol by-product fraction can contain a small amount of water-insoluble ODSO compounds, for example, in the range of from 1 to 10,000 ppmw. The alcohol by-product fraction can contain a small amount of water-soluble ODSO compounds, for example, in the range of from 100 to 50,000 ppmw.

In some embodiments, an ODSO is added in an amount by mass of ODSO, relative to the total mass of “free” water and ODSO, in the range of from about 0.1 to 50%, 0.1 to 20%, 0.1 to 15%, 0.1 to 10% or 0.1 to 5%. In some embodiments, ODSO is added in an amount by mass of ODSO, relative to the total mass of water and ODSO, in the range of from about 0.5 to 17%, 0.5 to 10%, 0.5 to 7.5%, 0.5 to 5% or 0.5 to 3%. In some embodiments, the zeolite is a ZSM-5 zeolite and ODSO is added in an amount by mass of ODSO, relative to the total mass of water and ODSO, in the range of from about 3 to 15%. In some embodiments, the zeolite is a *BEA zeolite and ODSO is added in an amount by mass of ODSO, relative to the total mass of water and ODSO, in the range of from about 0.1 to 17%. In some embodiments, the zeolite is a FAU zeolite and ODSO is added in an amount by mass of ODSO, relative to the total mass of water and ODSO, in the range of from about 1 to 12%.

In certain embodiments, the ODSO is derived from a sulfur-containing refinery waste stream of disulfide oil and is used as a co-solvent in the process of synthesizing one or more zeolites. One or more of these zeolites can have greater hierarchical nature than that of a comparative zeolite, and wherein the comparative zeolite is formed of approximately equivalent composition of components except for water instead of the added ODSO. The hierarchical nature can be a textural property such as one or more of the specific surface area, total pore volume, mesoporous volume, relative contribution of mesopores to a total volume of the zeolite, mesopore surface area, relative contribution of mesopores to a total surface area of the zeolite, or a combination thereof. In some embodiments, the hierarchical nature that is enhanced is the specific surface area, and the specific surface area of the zeolite is in the range of about 1-200, 10-200, 50-200, 1-150, 10-150, 50-150, 1-100, 10-100, or 50-100% greater than a comparative zeolite that is formed in the absence of ODSO of approximately equivalent compositional ratio effective for the zeolite except for water instead of the added ODSO. In some embodiments, the hierarchical nature that is enhanced is the total pore volume, and wherein the total pore volume of the zeolite is in the range of about 1-200, 10-200, 50-200, 1-150, 10-150, 50-150, 1-100, 10-100, or 50-100% greater than a comparative zeolite that is formed in the absence of ODSO of approximately equivalent compositional ratio effective for the zeolite except for water instead of the added ODSO. In some embodiments, the hierarchical nature that is enhanced is the mesoporous volume, and wherein the mesoporous volume of the zeolite is in the range of about 1-200, 10-200, 50-200, 1-150, 10-150, 50-150, 1-100, 10-100, or 50-100% greater than a comparative zeolite that is formed in the absence of ODSO of approximately equivalent compositional ratio effective for the zeolite except for water instead of the added ODSO. In some embodiments, the hierarchical nature that is enhanced is the relative contribution of mesopores to a total volume of the zeolite, and wherein the relative contribution of mesopores to a total volume of the zeolite is in the range of about 1-150, 10-150, 50-150, 1-100, 10-100, 50-100, 1-50, or 10-50% greater than a comparative zeolite that is formed in the absence of ODSO of approximately equivalent compositional ratio effective for the zeolite except for water instead of the added ODSO. In some embodiments, the hierarchical nature that is enhanced is the mesopore surface area of the zeolite, and wherein the mesopore surface area of the zeolite is in the range of about 1-750, 100-750, 300-750, 1-500, 100-500, 300-500, 1-400, 100-400, or 300-400% greater than a comparative zeolite that is formed in the absence of ODSO of approximately equivalent compositional ratio effective for the zeolite except for water instead of the added ODSO. In some embodiments, the hierarchical nature that is enhanced is the relative contribution of mesopores to a total surface area of the zeolite, and wherein the relative contribution of mesopores to a total surface area of the zeolite is in the range of about 1-400, 50-400, 100-400, 1-300, 50-300, 100-300, 1-200, 50-200, or 100-200% greater than a comparative zeolite that is formed in the absence of ODSO of approximately equivalent compositional ratio effective for the zeolite except for water instead of the added ODSO.

The enhanced textural properties reduce diffusion limitations and improve accessibility to active sites. One or more of these zeolites can be formed by a non-classical route/mechanism, whereas a comparative zeolite that formed of approximately equivalent composition of components except for water instead of the added ODSO would be formed under a classical route/mechanism under the same conditions. The addition of the ODSO can be thought of as inducing a switch from the classical to non-classical route. Non-classical growth provides zeolites comprising an agglomeration of smaller particles that can offer hierarchical zeolites, whereas classical growth provides zeolites comprising single particles. In some embodiments, the zeolite has a morphology that comprises an agglomeration of individual zeolite particles characterized by an agglomeration average dimension, and wherein each individual zeolite particle is characterized by an average dimension that is about 1-99% smaller than the agglomeration average dimension. Thus, the zeolites produced according to one or more embodiments of this invention demonstrate improved textural properties and are expected to have improved catalytic properties and activity/selectivity.

In some embodiments, hierarchical zeolite can be produced that are characterized by simultaneously having an intercrystalline mesopore and an intragranular micropore structure.

### EXAMPLES

The below examples and data are exemplary. It is to be understood that other ratios and types of aluminum sources, silica sources, bases and structure directing agents can be used as compared to the examples.

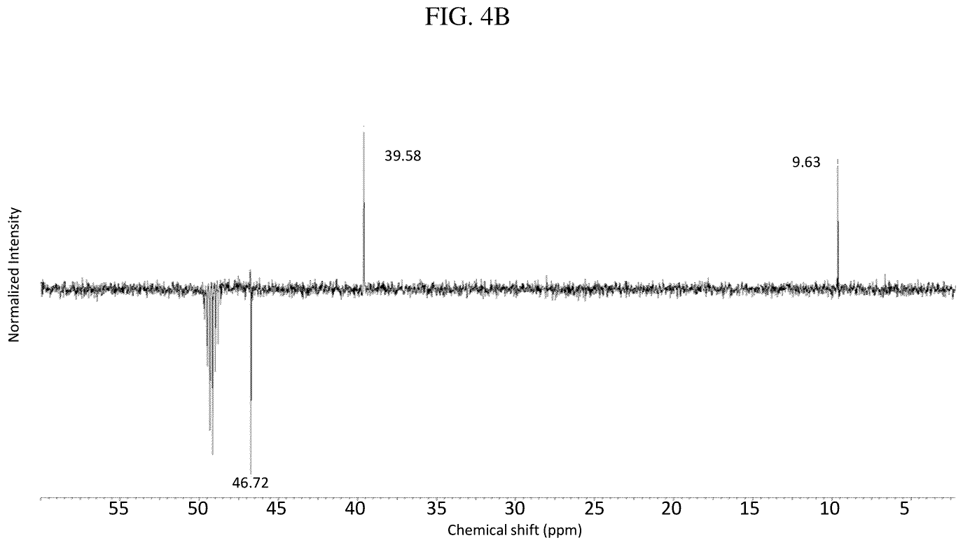

Reference Example: The ODSO mixtures used in the Examples below were produced as disclosed in U.S. Pat. No. 10,781,168, incorporated by reference above, and in particular the fraction referred to therein as Composition 2. Catalytic oxidation a hydrocarbon refinery feedstock having 98 mass percent of C1 and C2 disulfide oils was carried out. The oxidation of the DSO compounds was performed in batch mode under reflux at atmospheric pressure, that is, approximately 1.01 bar. The hydrogen peroxide oxidant was added at room temperature, that is, approximately 23° C. and produced an exothermic reaction. The molar ratio of oxidant-to-DSO compounds (calculated based upon mono-sulfur content) was 2.90. After the addition of the oxidant was complete, the reaction vessel temperature was set to reflux at 80° C. for approximately one hour. after which the water soluble ODSO was produced (referred to as Composition 2 herein and in U.S. Pat. No. 10,781,168) and isolated after the removal of water. The catalyst used in the oxidation of the DSO compounds was sodium tungstate. The Composition 2, referred to herein as “the selected water soluble ODSO fraction,” was used. FIG. 4A is the experimental ¹H-NMR spectrum of the polar, water soluble ODSO mixture that is the selected water soluble ODSO fraction in the example herein. FIG. 4B is the experimental ¹³C-DEPT-135-NMR spectrum of the polar, water soluble ODSO mixture that is the selected water soluble ODSO fraction in the example herein. The selected water soluble ODSO fraction was mixed with a CD₃OD solvent and the spectrum was taken at 25° C. Methyl carbons have a positive intensity while methylene carbons exhibit a negative intensity. The peaks in the 48-50 ppm region belong to carbon signals of the CD₃OD solvent.

When comparing the experimental ¹³C-DEPT-135-NMR spectrum of FIG. 4B for the selected water soluble ODSO fraction with a saved database of predicted spectra, it was found that a combination of the predicted alkyl-sulfoxidesulfonate (R—SO—SOO—OH), alkyl-sulfonesulfonate (R—SOO—SOO—OH), alkyl-sulfoxidesulfinate (R—SO—SO—OH) and alkyl-sulfonesulfinate (R—SOO—SO—OH) most closely corresponded to the experimental spectrum. This suggests that alkyl-sulfoxidesulfonate (R—SO—SOO—OH), alkyl-sulfonesulfonate (R—SOO—SOO—OH), alkyl-sulfoxidesulfinate (R—SO—SO—OH) and alkyl-sulfonesulfinate (R—SOO—SO—OH) are major compounds in the selected water soluble ODSO fraction. It is clear from the NMR spectra shown in FIGS. 4A and 4B that the selected water soluble ODSO fraction comprises a mixture of ODSO compounds that form an ODSO acid of the present disclosure and used in the present examples.

### Comparative Example 1

In a comparative example, zeolite beta was synthesized using conventional precursors and water as solvent with an initial sol-gel SAR of about 30. Aluminum nitrate nonahydrate (0.6955 g) was weighed into a polytetrafluoroethylene (PTFE) liner (45 ml). Then, 0.8144 g of a 50 wt. % sodium hydroxide solution and 5.0878 g tetraethylammonium hydroxide (TEAOH, 40 wt. %) were added to the aluminum nitrate nonahydrate and the mixture stirred until the aluminum source dissolved. Next, distilled water (6.2386 g) was added to the mixture which was kept under stirring. A silica source (4.1737 g of Ludox AS-40, SiO₂ content of 40 wt. %), was added and the mixture stirred until homogeneous. The PTFE liner was positioned within an autoclave and transferred to an oven. The mixture was heated to a temperature of 140° C. while the autoclave was rotated. The autoclave was kept at isothermal conditions for 6 days. Thereafter, the product was filtered and washed with distilled water before drying at 110° C. The dry mass was 1.1530 g. The inorganic content determined by thermogravimetric (TGA) analysis was 79.1%, which corresponds to a zeolite yield of 0.9119 g. The as-made sample was calcined at 550° C. (1° C./min ramp rate) for 8 hours to realize the porous zeolite. The ODSO/Na ratio was 0 (no ODSO was used in the synthesis for Comparative Example 1).

### Example 1

ODSO as described in the Reference Example was added to a homogeneous aqueous mixture used to synthesize zeolite beta with an approximately equivalent compositional ratio of precursors and reagents as in the Comparative Example 1, and also including ODSO at an ODSO/Na ratio (g/g) of about 1.33 (equivalent to an amount by mass of ODSO, relative to the total mass of “free” water and ODSO, of 5%, and equivalent to an amount by mass of ODSO, relative to the total mass of water and ODSO, of 2.49%). Ratios of other components were approximately equivalent to those in the Comparative Example 1 including an initial sol-gel SAR of about 30. Aluminum nitrate nonahydrate (0.6943 g) was weighed into a polytetrafluoroethylene (PTFE) liner (45 ml). Then, 0.8135 g of a 50 wt. % sodium hydroxide solution and 5.1063 g tetraethylammonium hydroxide (TEAOH, 40 wt. %) were added to the aluminum nitrate nonahydrate and the mixture stirred until the aluminum source dissolved. Next, distilled water (5.9178 g) and ODSO (0.3111 g) were added which was kept under stirring. The silica source (4.1695 g of Ludox AS-40, SiO₂ content of 40 wt. %) was added and the mixture stirred until homogeneous. The PTFE liner was positioned within an autoclave and transferred to an oven. The mixture was heated to a temperature of 140° C. while the autoclave was rotated. The autoclave was kept at isothermal conditions for 6 days. Then, the product was filtered and washed with distilled water before drying at 110° C. The dry mass was 1.3452 g. The inorganic content determined by thermogravimetric (TGA) analysis was 77.1%, which corresponds to a zeolite yield of 1.0371 g. The as-made sample was calcined at 550° C. (1° C./min ramp rate) for 8 hours to realize the porous zeolite.

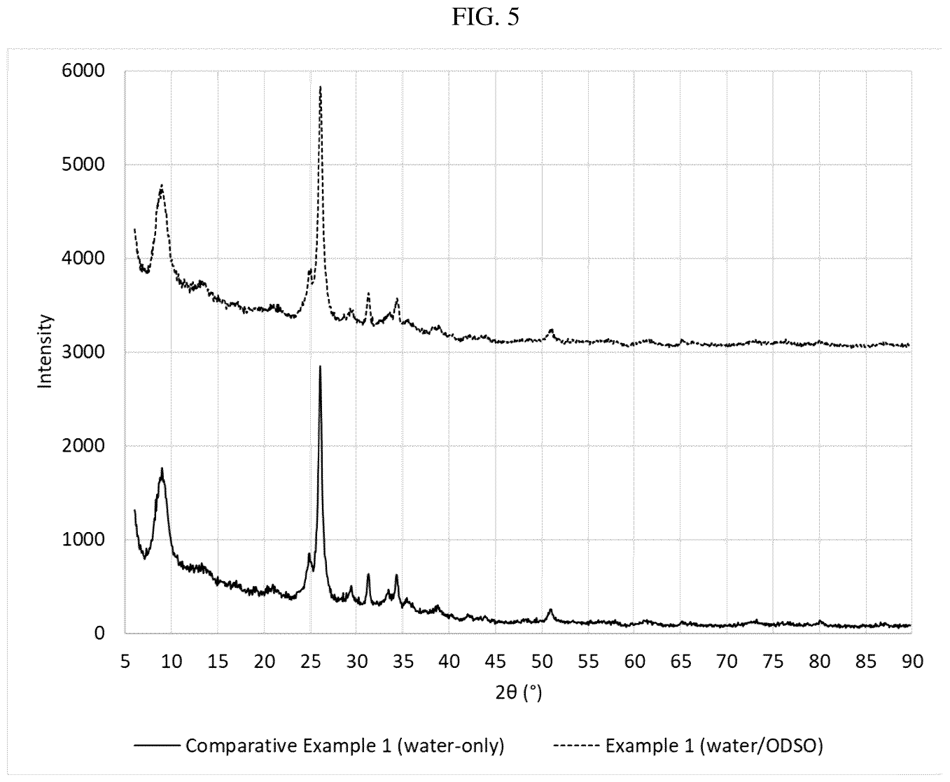

FIG. 5 shows the x-ray diffraction patterns of the as-made zeolites from Comparative Example 1 and Example 1. The diffraction patterns are off-set for clarity and normalized to the highest peak intensity. It is clear that both Examples produced zeolite beta.

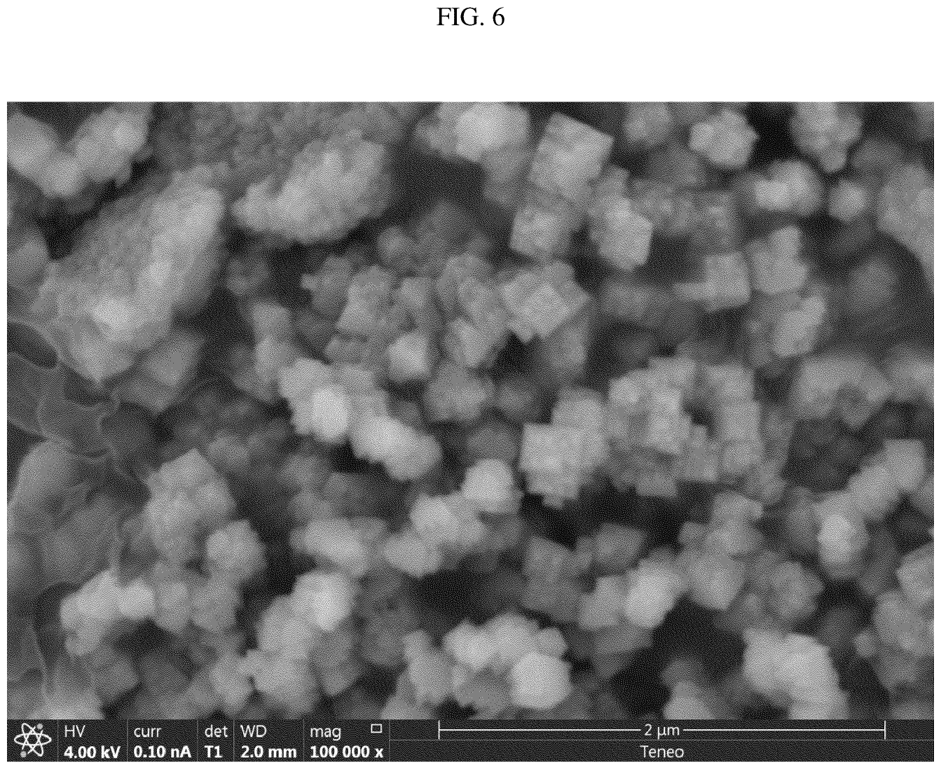

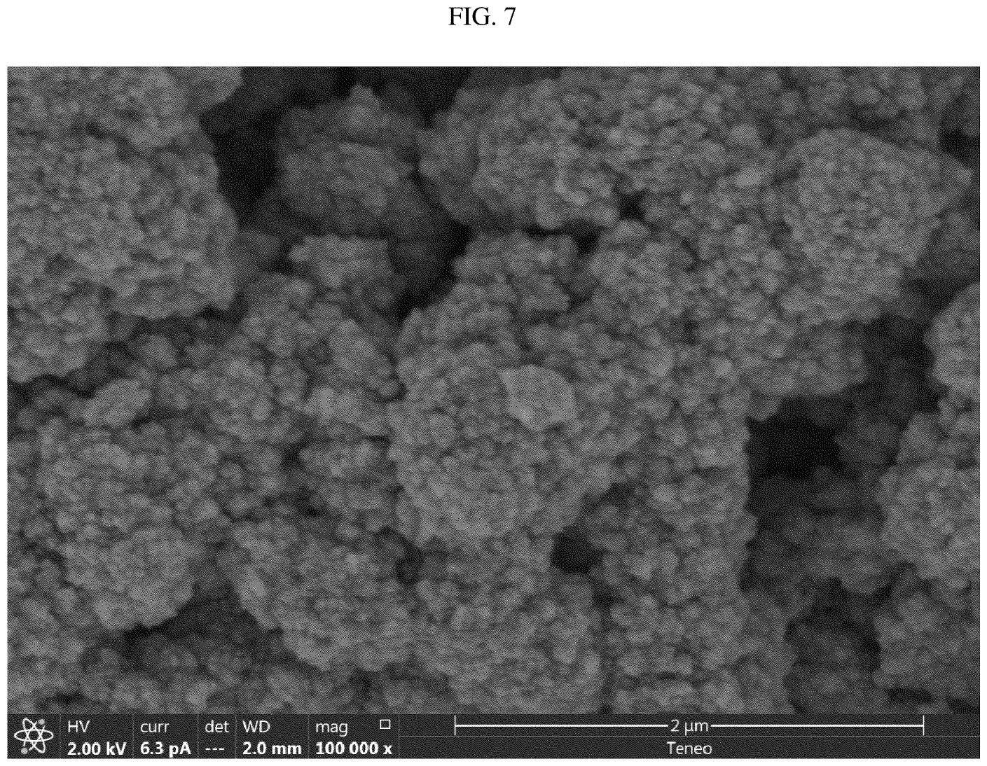

FIG. 6 shows a SEM micrograph of the zeolite beta from Comparative Example 1, synthesized in the absence of ODSO at a scale-bar of 2 μm. FIG. 7 is a SEM micrograph (also at a scale-bar of 2 μm) of the zeolite beta from Example 1, synthesized in the presence of ODSO. It is clear that the morphology between the two zeolite beta samples are different, namely that the zeolite beta synthesized in the absence of ODSO is characterized by larger singular-type particles, whereas the zeolite beta product synthesized in the presence of ODSO is characterized by much smaller agglomerates of particles.

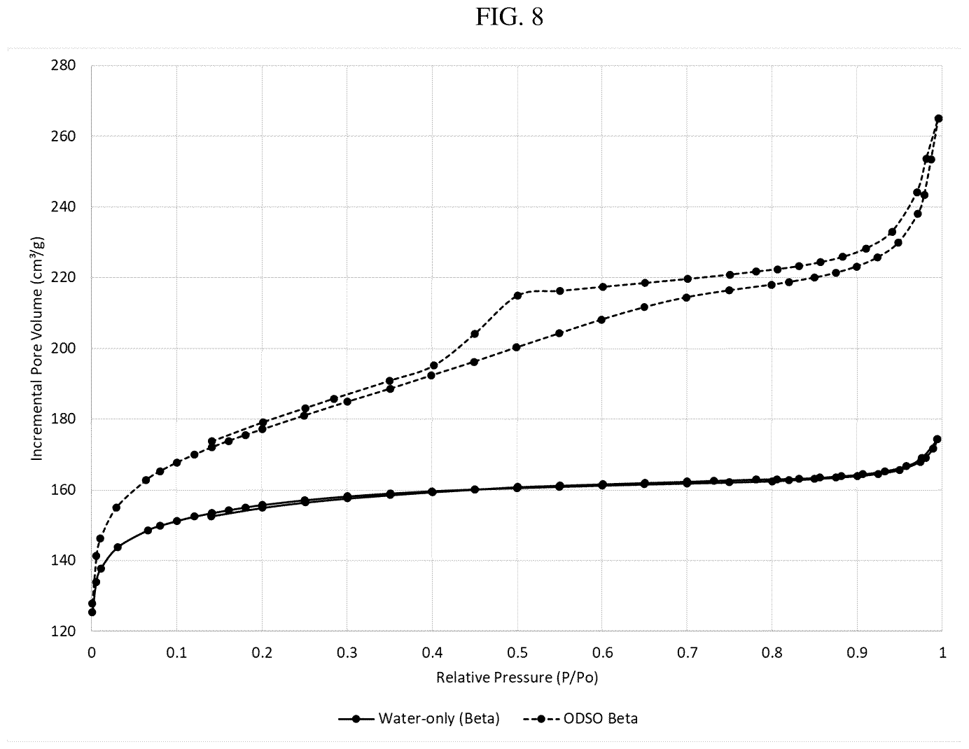

FIG. 8 provides nitrogen adsorption isotherms of the calcined zeolite beta products of Comparative Example 1 and Example 1 (incremental pore volume in cm³/g plotted against relative pressure (P/P₀)). The hierarchical nature between the two samples was observed by their textural properties through nitrogen adsorption measurements in FIG. 8. The zeolite beta synthesized in the absence of ODSO exhibited a type I isotherm relating to a microporous zeolite, whereas the isotherm for the zeolite beta synthesized in the presence of ODSO is a type IV isotherm reflecting significant mesoporosity. Although the adsorption branch of the isotherm for the zeolite beta synthesized in the presence of ODSO indicated that there is a broad mesopore size distribution as a result of the continuous adsorbate uptake over a broad pressure range, the adsorbate uptake at P/P₀>0.95 was indicative of interparticle mesoporosity, that is, the interstitial sites between small particles as a result of the non-classical growth, which was not observed to the same extent for the zeolite beta synthesized in the absence of ODSO formed via a classical growth mechanism. However, the hysteresis loop suggests that there is also mesoporosity associated with intra-particle mesopores.

Table 5 details the textural properties. The zeolite beta synthesized in the absence of ODSO has a specific surface area of 611 m²/g and the zeolite beta synthesized in the presence of ODSO a specific surface area of 623 m²/g, however, the contribution of the mesoporous surface area to the total surface area is 177 m²/g and 219 m²/g, respectively. Therefore, the mesoporous surface area per gram of the zeolite beta synthesized in the presence of ODSO is 87% greater than the zeolite beta synthesized in the absence of ODSO, a characteristic that is beneficial to allow ingress of large guest species, for example, hydrocarbon molecules, to active sites of the zeolite beta. The total pore volume of the zeolite beta synthesized in the absence of ODSO is 0.28 cc/g and the zeolite beta synthesized in the presence of ODSO has a total pore volume of 0.36 cc/g, an increase of 29% over that of the zeolite beta synthesized in the absence of ODSO. The contribution of the mesoporous volume to the total pore volume is 0.08 cc/g and 0.20 m²/g, respectively. Therefore, the mesoporous volume/g of the zeolite beta synthesized in the presence of ODSO is 150% greater than the equivalent zeolite beta synthesized in the absence of ODSO, a characteristic that is beneficial to allow ingress of large guest species, for example, hydrocarbon molecules, to active sites.

### Comparative Example 2

In a comparative example, zeolite Y was synthesized using conventional precursors and water as solvent with an initial sol-gel SAR of about 9.2. Sodium aluminate (1.3991 g) was weighed into a polytetrafluoroethylene (PTFE) liner (45 ml). Thereafter, 2.7868 g of a 50 wt. % sodium hydroxide solution and water (13.5570 g) were added and the mixture stirred until the aluminum source dissolved. The silica source (10.0138 g of Ludox AS-40, SiO₂ content of 40 wt. %) was added and the mixture stirred until homogeneous. The mixture was left to age for 24 hours at room temperature (20° C.) under constant stirring. The PTFE liner was positioned within an autoclave and transferred to an oven. The mixture was heated to a temperature of 90° C. while the autoclave was rotated. The autoclave was kept at isothermal conditions for 75 hours. Thereafter, the product was filtered and washed with distilled water, and the sample was freeze-dried. The dry mass was 1.0584 g. The ODSO/Na ratio was 0 (no ODSO was used in the synthesis for Comparative Example 2).

### Example 2

ODSO as described in the Reference Example was added to a homogeneous aqueous mixture used to synthesize zeolite Y with an approximately equivalent compositional ratio of precursors and reagents as in Comparative Example 2, and also including ODSO at an ODSO/Na ratio (g/g) of about 2.54 (equivalent to an amount by mass of ODSO, relative to the total mass of “free” water and ODSO, of 15%, and equivalent to an amount by mass of ODSO, relative to the total mass of water and ODSO, of 9.7%). Ratios of other components are approximately equivalent to those in the Comparative Example 2 including an initial sol-gel SAR of about 9.2. Sodium aluminate (1.3991 g) was weighed into a polytetrafluoroethylene (PTFE) liner (45 ml). Thereafter, 2.7858 g of a 50 wt. % sodium hydroxide solution, water (11.5230 g) and ODSO (2.0331 g) were added and the mixture stirred until the aluminum source dissolved. The silica source (10.0139 g of Ludox AS-40, SiO₂ content of 40 wt. %) was added and the mixture stirred until homogeneous. The mixture was left to age for 24 hours at room temperature (20° C.) under constant stirring. The PTFE liner was positioned within an autoclave and transferred to an oven. The mixture was heated to a temperature of 90° C. while the autoclave was rotated. The autoclave was kept at isothermal conditions for 75 hours. Thereafter, the product was filtered and washed with distilled water, the sample was freeze-dried. The dry mass was 1.08 g.

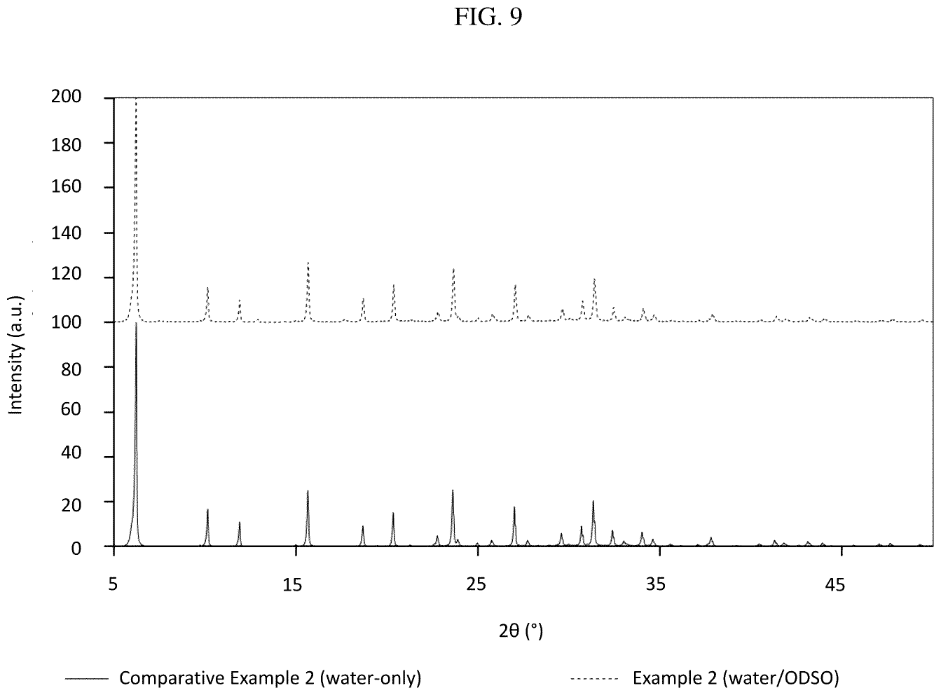

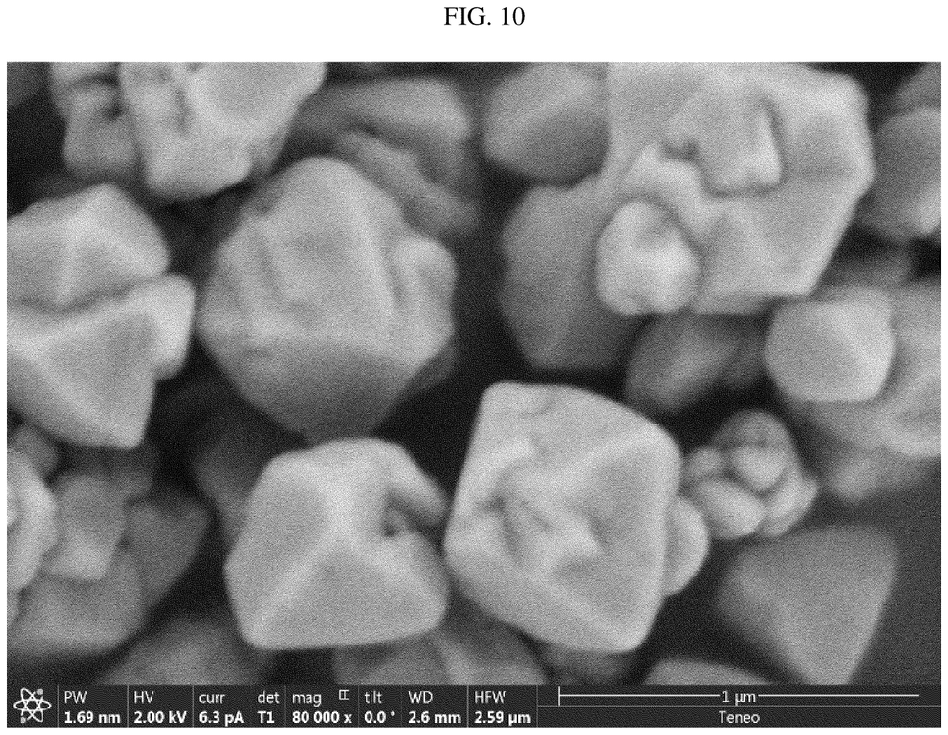

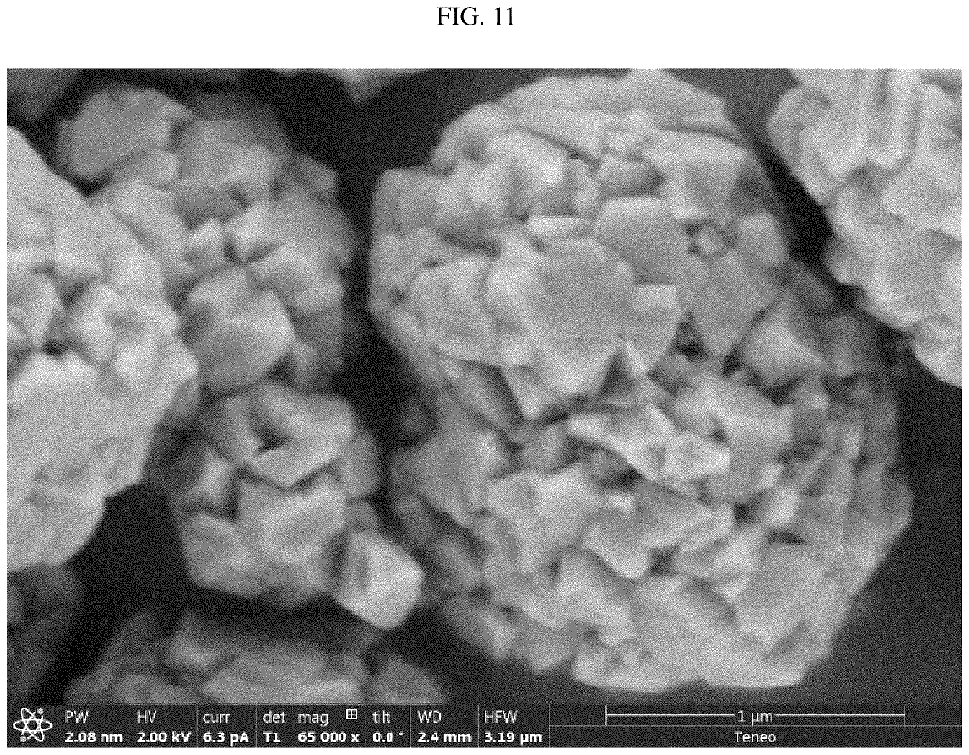

FIG. 9 shows the x-ray diffraction patterns of the as-made zeolites from Comparative Example 2 and Example 2. The diffraction patterns are off-set for clarity and normalized to the highest peak intensity. It is clear that both Examples produced zeolite Y. FIG. 10 shows a SEM micrograph of the zeolite Y from Comparative Example 2, synthesized in the absence of ODSO at a scale-bar of 1 μm. FIG. 11 is a SEM micrograph (also at a scale-bar of 1 μm) of the zeolite Y from Example 2, synthesized in the presence of ODSO. It is clear that the morphology between the two zeolite Y samples are different, namely that the zeolite Y synthesized in the absence of ODSO is characterized by larger singular-type particles, whereas the corresponding zeolite Y product synthesized in the presence of ODSO is characterized by much smaller agglomerates of particles. Zeolite Y with ODSO was not observed to increase the mesoporosity. This indicates that the zeolite formed in Example 2 was formed via the non-classical route but did not exhibit increased inter-particle mesoporosity.

### Comparative Example 3

In a comparative example, ZSM-5 zeolite was synthesized using conventional precursors and water as solvent with an initial sol-gel SAR of about 100. Aluminum nitrate nonahydrate (0.2633 g) was weighed into a polytetrafluoroethylene liner (45 ml). Thereafter, 0.7750 g of a 50 wt. % sodium hydroxide solution and 7.0469 g tetrapropylammonium hydroxide (TPAOH) were added and the mixture stirred. Next, distilled water (3.3005 g) was added and the mixture was maintained under stirring. Finally, the silica source (5.2430 g of Ludox AS-40, SiO₂ content of 40 wt. %) was added and the mixture stirred until homogeneous. The polytetrafluoroethylene liner was positioned within an autoclave and transferred to an oven. The mixture was heated to a temperature of 175° C. while the autoclave was rotated. The autoclave was maintained at isothermal conditions for 18 hours. The product was filtered and washed with distilled water before drying at 110° C. The dry mass was 1.3906 g. The inorganic content determined by thermogravimetric (TGA) analysis was 87.78%. Hence, a product (zeolite) yield of 1.2207 g was obtained. The as-made sample from Comparative Example 3 was calcined at 550° C. (1° C./min ramp rate) for 8 hours to realize a porous ZSM-5 zeolite. The ODSO/Na ratio was 0 (no ODSO was used in the synthesis for Comparative Example 3).

### Example 3

ODSO as described in the Reference Example was added to the homogeneous aqueous mixture used to synthesize ZSM-5 zeolite with an approximately equivalent compositional ratio of precursors and reagents as in Comparative Example 3, and also including ODSO at an ODSO/Na ratio (g/g) of about 5.31 (equivalent to an amount by mass of ODSO, relative to the total mass of “free” water and ODSO, of 35%, and equivalent to an amount by mass of ODSO, relative to the total mass of water and ODSO, of 9.5%). Ratios of other components are approximately equivalent to those in the Comparative Example 3 including an initial sol-gel SAR of about 100. Aluminum nitrate nonahydrate (0.2643 g) was weighed into a polytetrafluoroethylene liner (45 ml). Then, 0.7888 g of a 50 wt. % sodium hydroxide solution and 7.0383 g tetrapropylammonium hydroxide (TPAOH) were added and the mixture stirred. Next, distillated water (2.2038 g) and ODSO (1.2033 g) were added and the mixture was maintained under stirring. Finally, the silica source (5.2384 g of Ludox AS-40, SiO₂ content of 40 wt. %) was added and the mixture stirred until homogeneous. The polytetrafluoroethylene liner was positioned within an autoclave and transferred to an oven. The mixture was heated to a temperature of 175° C. while the autoclave was rotated. The autoclave was maintained at isothermal conditions for 18 hours. Thereafter, the product was filtered and washed with distilled water before drying at 110° C. The dry mass was 2.1103 g. The inorganic content determined by thermogravimetric (TGA) analysis was 86.61%. Hence, a zeolite yield of 1.8277 g was obtained.

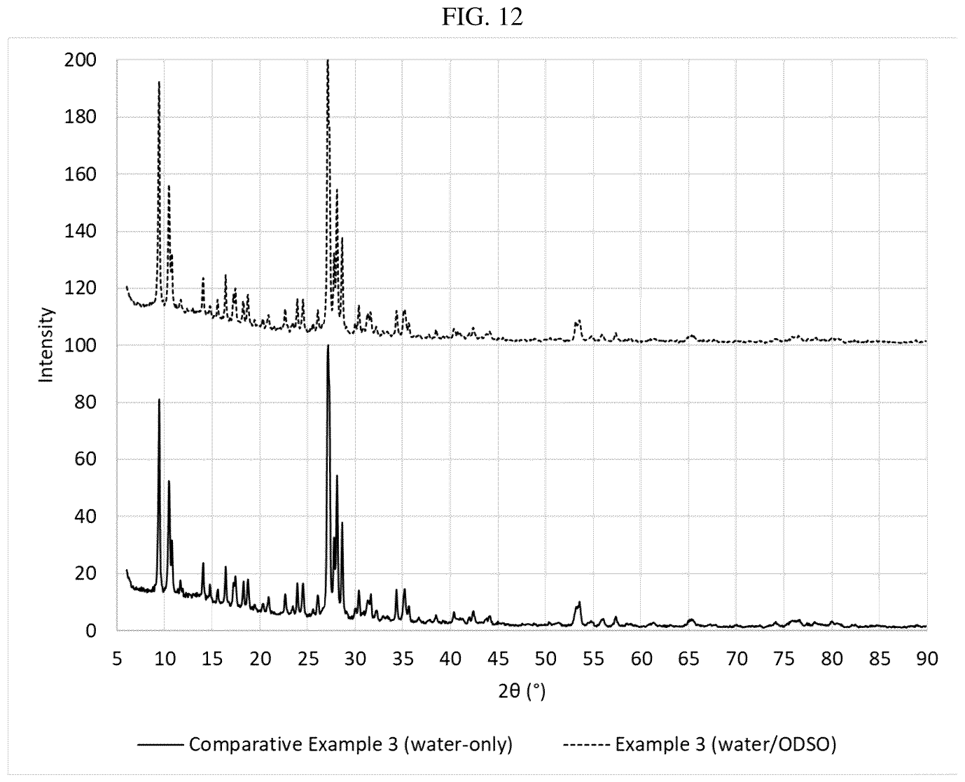

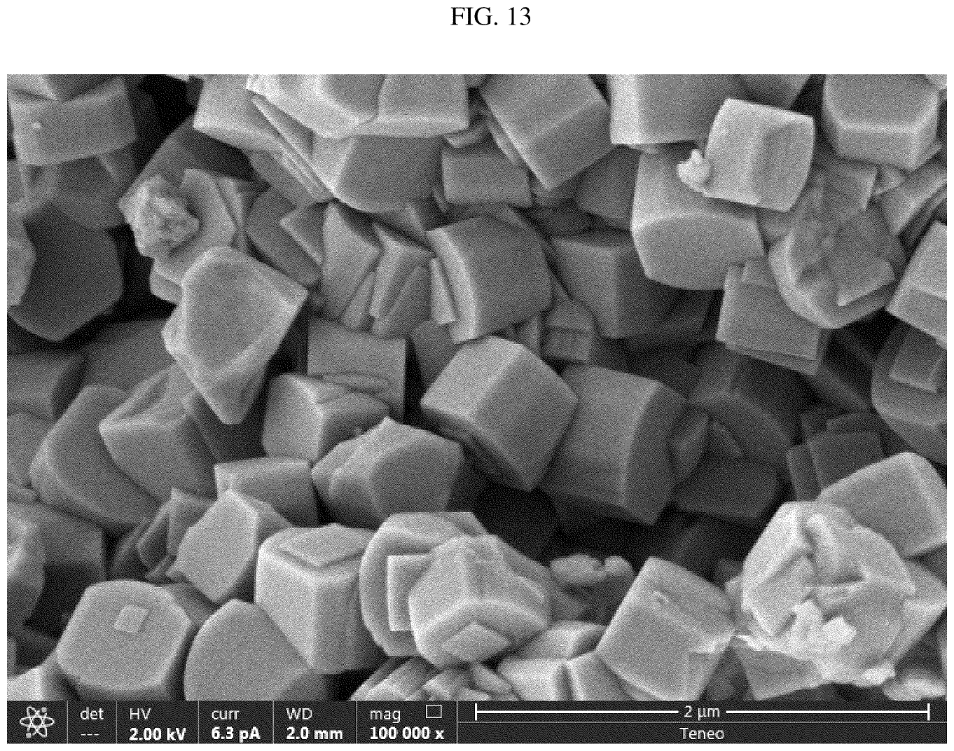

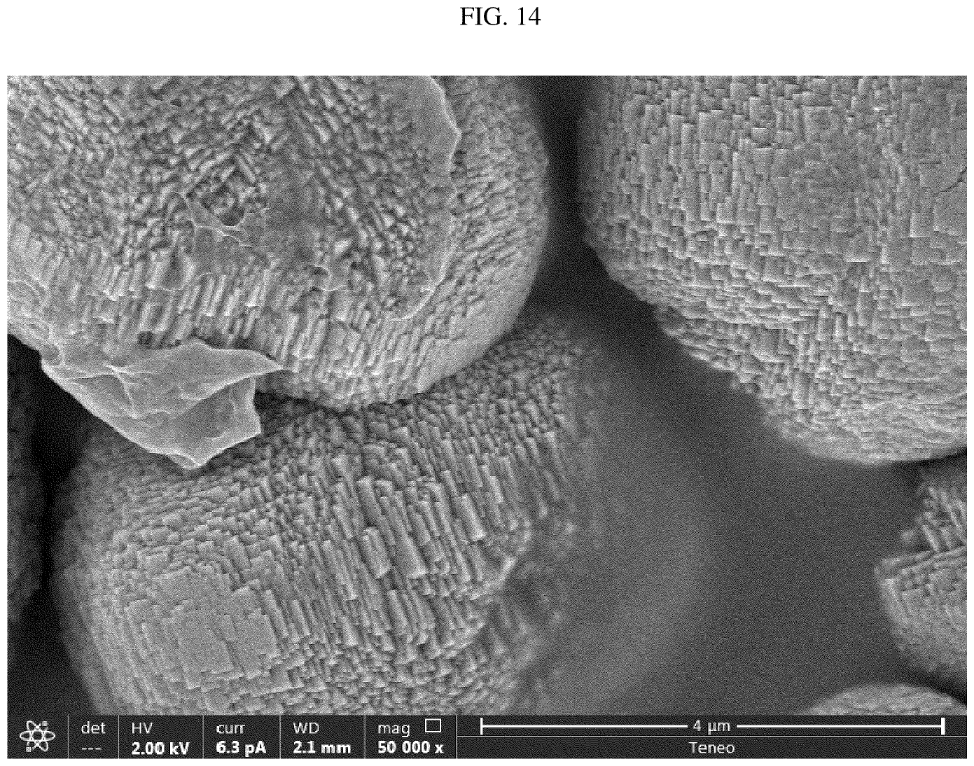

FIG. 12 shows the x-ray diffraction patterns of the as-made zeolites from Comparative Example 3 and Example 3. The diffraction patterns are off-set for clarity and normalized to the highest peak intensity. It is clear that both Examples produced zeolite ZSM-5. FIG. 13 shows a SEM micrograph of the zeolite ZSM-5 from Comparative Example 3, synthesized in the absence of ODSO at a scale-bar of 2 μm. FIG. 14 is a SEM micrograph (at a scale-bar of 4 μm) of the equivalent zeolite ZSM-5 from Example 3, synthesized in the presence of ODSO. It is clear that the morphology between the two zeolite ZSM-5 samples are different, namely that the zeolite ZSM-5 synthesized in the absence of ODSO is characterized by larger singular-type particles, whereas the corresponding equivalent zeolite ZSM-5 product synthesized in the presence of ODSO is characterized by much smaller agglomerates of particles, albeit that the overall particle size of the agglomeration of smaller particles is larger overall. The SEM clearly shows the differences between classical growth (the water-only examples, that is, in the absence of ODSO) and non-classical growth (the ODSO examples, that is, synthesized in the presence of ODSO).

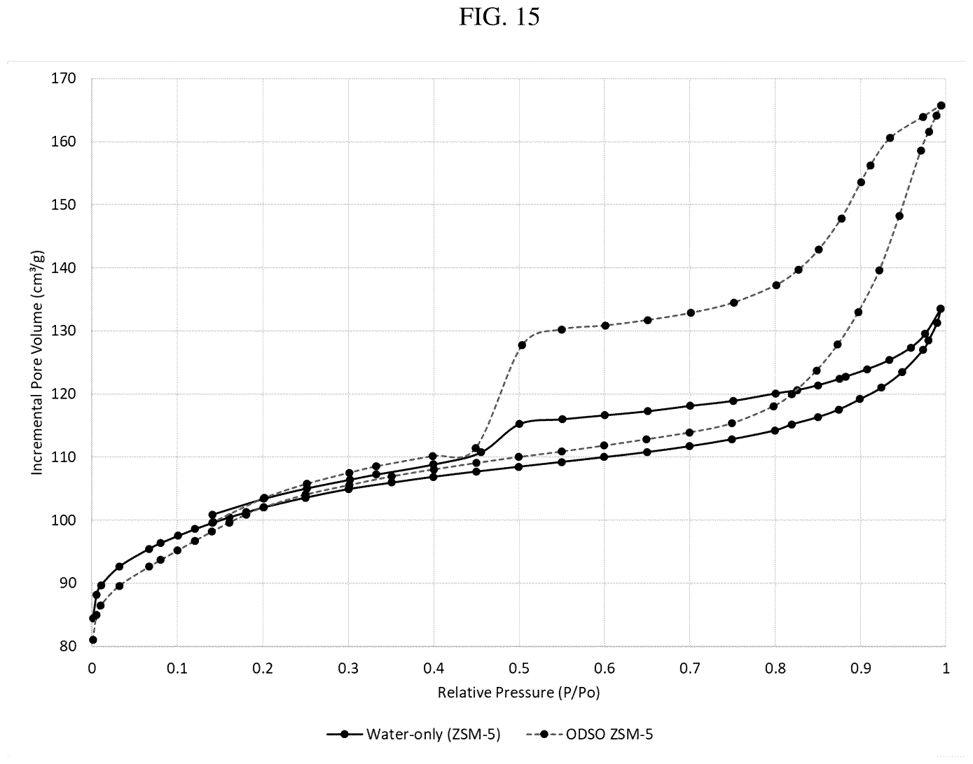

FIG. 15 provides nitrogen adsorption isotherms of the calcined zeolite ZSM-5 products of Comparative Example 3 and Example 3 (incremental pore volume in cm³/g plotted against relative pressure (P/P₀)). The hierarchical nature between the two samples was observed by their textural properties through nitrogen adsorption measurements in FIG. 15. The ZSM-5 zeolite synthesized in the absence of ODSO demonstrated less porosity than the equivalent ZSM-5 zeolite synthesized in the presence of ODSO. The adsorption branch of the isotherm for the ZSM-5 zeolite synthesized in the presence of ODSO indicated that there is a broad mesopore size distribution as a result of the continuous adsorbate uptake over a broad pressure range, the adsorbate uptake at P/P₀>0.80 was indicative of interparticle mesoporosity, that is, the interstitial sites between small particles as a result of the non-classical growth, which was not observed to the same extent for the ZSM-5 zeolite synthesized in the absence of ODSO and which was formed via a classical growth mechanism.

Table 6 details the textural properties. The ZSM-5 zeolite synthesized in the absence of ODSO had a specific surface area of 392 m²/g and the ZSM-5 synthesized in the presence of ODSO had a specific surface area of 379 m²/g, however, the contribution of the mesoporous surface area to the total surface area is 97 m²/g and 142 m²/g, respectively. Therefore, the mesoporous surface area/g of the ZSM-5 zeolite synthesized in the presence of ODSO is 46% greater than the ZSM-5 synthesized in the absence of ODSO, a characteristic that is beneficial to allow ingress of large guest species, for example, hydrocarbon molecules, to active sites. The total pore volume of the ZSM-5 zeolite synthesized in the absence of ODSO was 0.19 cc/g and the ZSM-5 synthesized in the presence of ODSO had a total pore volume of 0.23 cc/g. The contribution of the mesoporous volume to the total pore volume is 0.08 cc/g and 0.13 m²/g, respectively. Therefore, the mesoporous volume/g of the ZSM-5 zeolite synthesized in the presence of ODSO is 63% greater than the ZSM-5 synthesized in the absence of ODSO, a characteristic that is beneficial to allow ingress of large guest species, for example, hydrocarbon molecules, to active sites.

### Comparative Example 4

In a comparative example, (ANA) zeolite was synthesized using conventional precursors and water as solvent with an initial sol-gel SAR of about 25. Aluminum nitrate nonahydrate (0.2683 g) was weighed into a polytetrafluoroethylene (PTFE) liner (45 ml). Thereafter, 0.7511 g of a 50 wt. % sodium hydroxide solution and 7.0193 g of a 20 wt. % tetrapropylammonium hydroxide (TPAOH) solution were added and the mixture stirred. Next, distilled water (5.6160 g) was added and the mixture was kept under stirring. The silica source (1.3051 g, 40 wt. %) was added and the mixture stirred until homogeneous. The pH of the sol-gel before heating was about 14, and the pH of the mother liquor after crystallization was about 14. The PTFE liner was positioned within an autoclave and transferred to an oven. The mixture was heated to a temperature of 175° C. while the autoclave was rotated. The autoclave was maintained at isothermal conditions for 18 hours. The product was filtered and washed with distilled water before drying at 110° C. The dry mass was 0.1550 g. X-ray diffraction shows the product to be analcime (ANA). The as-made sample from Comparative Example 4 was calcined at 550° C. for 8 hours (2° C./min ramp rate to 150° C., hold for 5 hours, 1.5° C./min ramp rate to 550° C.) to render the product porous. The ODSO/Na ratio was 0 (no ODSO was used in the synthesis for Comparative Example 4).

### Example 4A

ODSO as described in the Reference Example was added to the homogeneous aqueous mixture with an approximately equivalent compositional ratio of precursors and reagents as in Comparative Example 4, and also including ODSO at an ODSO/Na ratio (g/g) of about 3.1 (equivalent to an amount by mass of ODSO, relative to the total mass of “free” water and ODSO, of 12%, and equivalent to an amount by mass of ODSO, relative to the total mass of water and ODSO, of 5.4%). Ratios of other components are approximately equivalent to those in the Comparative Example 4 including an initial sol-gel SAR of about 25. Aluminum nitrate nonahydrate (0.2637 g) was weighed into a PTFE liner (45 ml). Then, 0.7550 g of a 50 wt. % sodium hydroxide solution and 7.0275 g of a 20 wt. % TPAOH solution were added and the mixture stirred. Next, distilled water (4.9420 g) and ODSO (0.6695 g) were added and the mixture was kept under stirring. The silica source (1.3025 g of Ludox AS-40, SiO₂ content of 40 wt. %) was added and the mixture stirred until homogeneous. The pH of the sol-gel before heating was about 14, and the pH of the mother liquor after crystallization was about 14. The PTFE liner was positioned within an autoclave and transferred to an oven. The mixture was heated to a temperature of 175° C. while the autoclave was rotated. The autoclave was maintained at isothermal conditions for 18 hours. The product was filtered and washed with distilled water before drying at 110° C. The dry mass was 0.2315 g. X-ray diffraction shows the product to be principally ZSM-5 (MFI) with (ANA). The as-made sample from Example 4 Å was calcined at 550° C. for 8 hours (2° C./min ramp rate to 150° C., hold for 5 hours, 1.5° C./min ramp rate to 550° C.) to render the product porous.

### Example 4B

ODSO as described in the Reference Example was added to the homogeneous aqueous mixture with an approximately equivalent compositional ratio of precursors and reagents as in Comparative Example 4, and also including ODSO at an ODSO/Na ratio (g/g) of about 6.3 (equivalent to an amount by mass of ODSO, relative to the total mass of “free” water and ODSO, of 24%, and equivalent to an amount by mass of ODSO, relative to the total mass of water and ODSO, of 10.8%). Ratios of other components are approximately equivalent to those in the Comparative Example 4 including an initial sol-gel SAR of about 25. Aluminum nitrate nonahydrate (0.2642 g) was weighed into a PTFE liner (45 ml). Then, 0.7451 g of a 50 wt. % sodium hydroxide solution and 7.0216 g of a 20 wt. % TPAOH solution were added and the mixture stirred. Next, distilled water (4.2680 g) and ODSO (1.3470 g) were added and the mixture was kept under stirring. The silica source (1.3008 g of Ludox AS-40, SiO₂ content of 40 wt. %) was added and the mixture stirred until homogeneous. The pH of the sol-gel before heating was about 14, and the pH of the mother liquor after crystallization was about 13. The PTFE liner was positioned within an autoclave and transferred to an oven. The mixture was heated to a temperature of 175° C. while the autoclave was rotated. The autoclave was maintained at isothermal conditions for 18 hours. The product was filtered and washed with distilled water before drying at 110° C. The dry mass was 0.4203 g. X-ray diffraction shows the product to be ZSM-5 (MFI). The as-made sample from Example 4B was calcined at 550° C. for 8 hours (2° C./min ramp rate to 150° C., hold for 5 hours, 1.5° C./min ramp rate to 550° C.) to render the product porous.

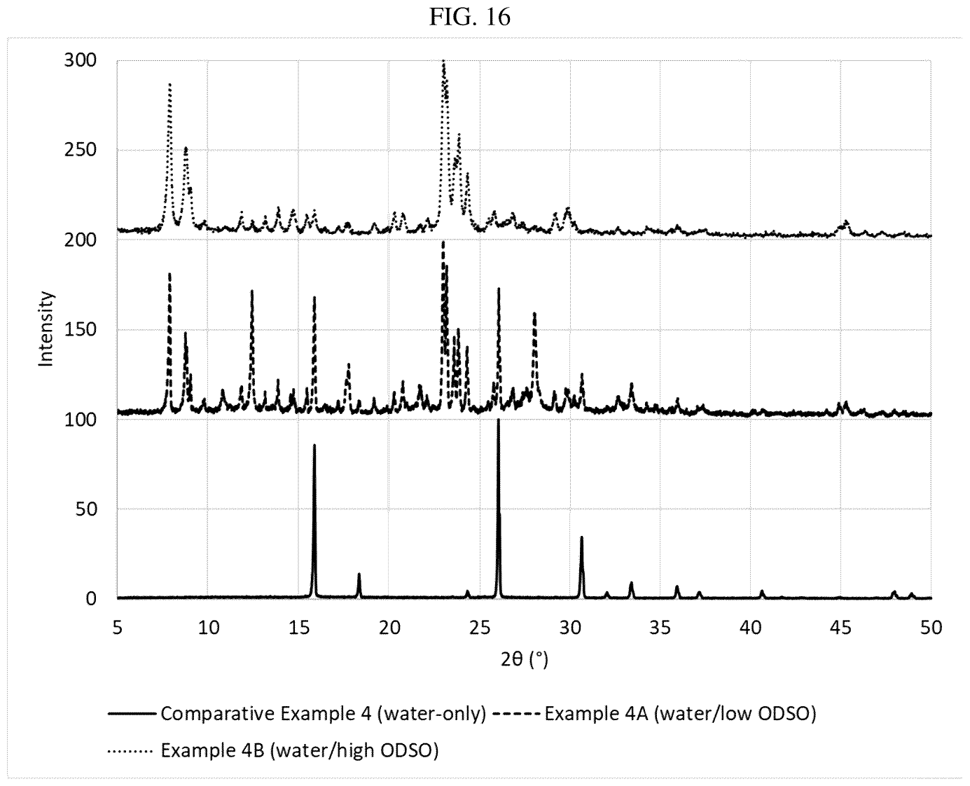

FIG. 16 shows the x-ray diffraction patterns of the as-made zeolites from Comparative Example 4 and Examples 4A and 4B. The diffraction patterns are off-set for clarity and normalized to the highest peak intensity. It is clear that the Comparative Example 4 product yields (ANA), whilst both Examples 4A and 4B produce zeolite ZSM-5, with Example 4 Å also containing (ANA). When the sol-gel SAR for ZSM-5 was reduced to 25, synthesis in the absence of ODSO yielded analcime (ANA) rather than ZSM-5 (MFI). Addition of ODSO changed the phase boundary to ZSM-5.

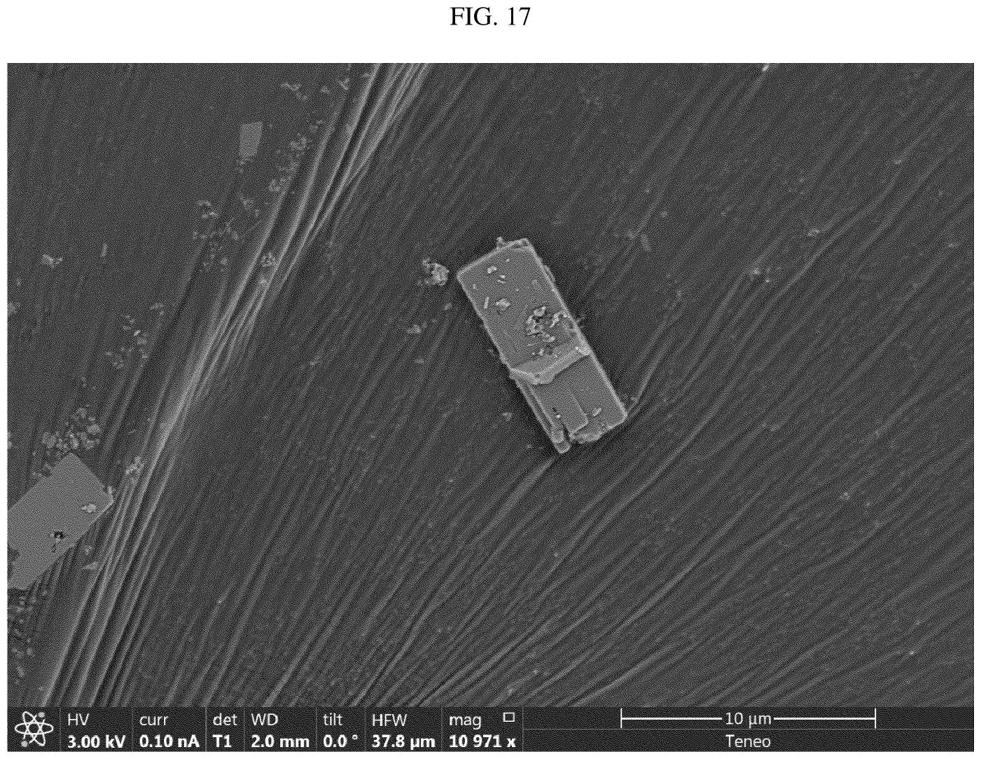

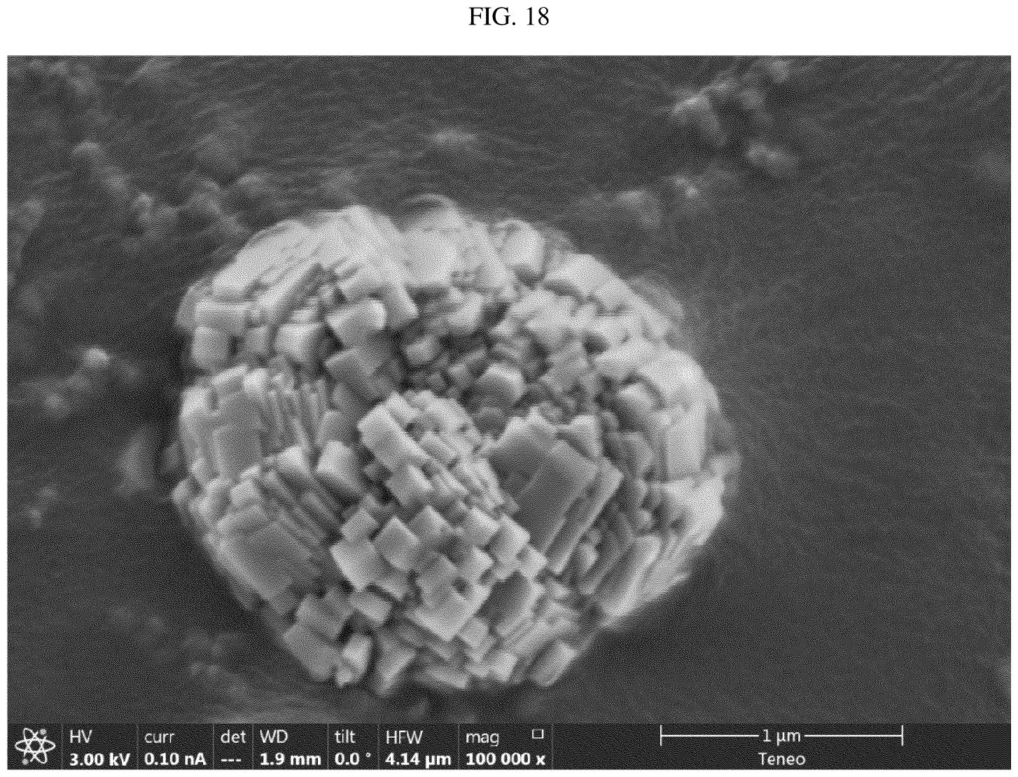

FIG. 17 shows a SEM micrograph of the ZSM-5 zeolite from Example 4 Å, synthesized in the presence of a lesser amount of ODSO at a scale-bar of 10 μm. FIG. 18 is a SEM micrograph (at a scale-bar of 1 μm) of the ZSM-5 zeolite from Example 4B, synthesized in the presence of a higher amount of ODSO. It is clear that the morphology between the two zeolite ZSM-5 samples are different, namely that the ZSM-5 zeolite synthesized in the presence of a lesser amount of ODSO has larger singular-type particles, whereas the corresponding ZSM-5 zeolite synthesized in the presence of a higher amount of ODSO exhibits much smaller agglomerates of particles, clearly demonstrating the switch between classical and non-classical growth formation. The synthesis in the absence of ODSO, Comparative Example 4, yielded (ANA).

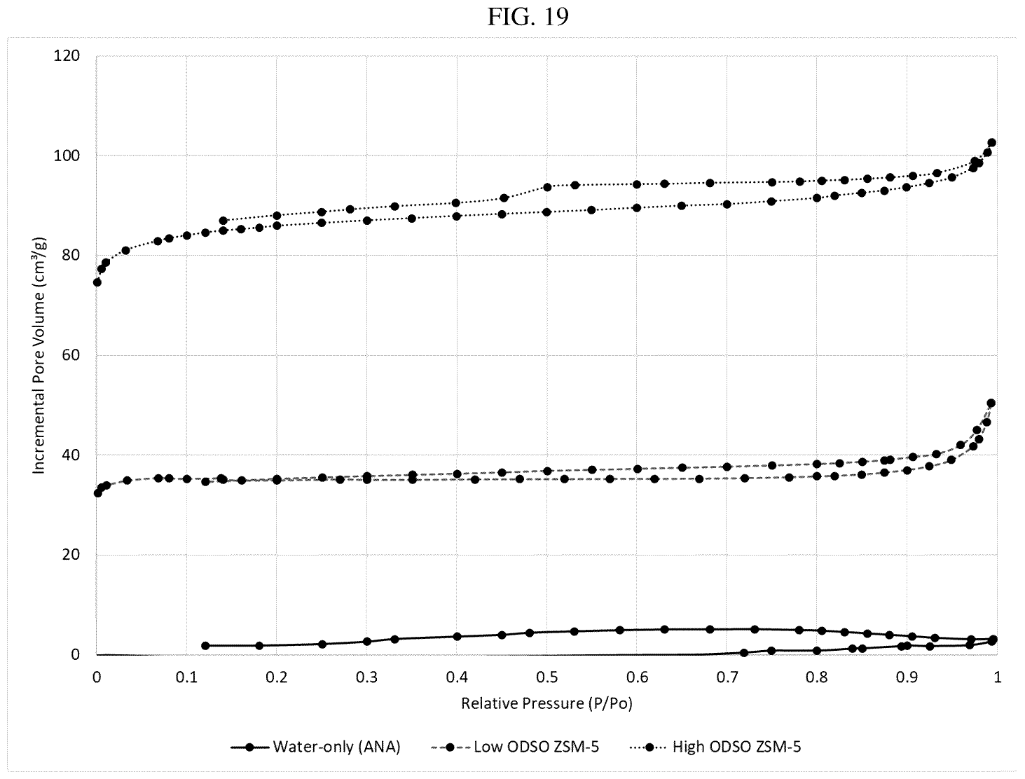

The hierarchical nature between the two samples is observed by their textural properties through nitrogen adsorption measurements in FIG. 19. The zeolite (ANA) material synthesized in the absence of ODSO is clearly non-mesoporous, whereas the isotherms for the equivalent ZSM-5 zeolites synthesized in the presence of ODSO have improved textural properties. At the lower ODSO loading the isotherm is type I, typical of a microporous material (although there is a degree of hysteresis present), whereas the isotherm of the ZSM-5 synthesized at the higher ODSO loading exhibits type I and type IV properties with some degree of mesoporosity in this material. The increased mesoporosity is said to be as a result of the properties induced by the switch to a non-classical growth, which is not observed for the low ODSO loading ZSM-5 zeolite formed via a classical growth mechanism.

Table 7 details the textural properties. The ZSM-5 zeolite synthesized in the absence of ODSO did not provide a specific surface area, whereas the ZSM-5 zeolites synthesized in the presence of ODSO, with low and high ODSO loading, gave specific surface areas of 147 m²/g and 342 m²/g, respectively; however, the contribution of the mesoporous surface area to the total surface area is 2 m²/g and 12 m²/g, respectively. Therefore, the mesoporous surface area/g of the ZSM-5 zeolite synthesized in the presence of higher loading of ODSO is 500% greater than the ZSM-5 zeolite synthesized in the presence of low loading of ODSO, beneficial to allow ingress of large guest species such as hydrocarbon molecules, to active sites. The total pore volume of the ZSM-5 zeolite synthesized in the absence of ODSO is negligible at 0.005 cc/g and the ZSM-5 zeolites synthesized in the presence of ODSO possess total pore volumes of 0.06 cc/g and 0.15 cc/g, for low and high ODSO loadings, respectively, and the contribution of the mesoporous volume to the total pore volume is 0.05 cc/g and 0.12 m²/g, respectively. Therefore, the mesoporous volume/g of the ZSM-5 zeolite synthesized in the presence of higher loading of ODSO is 140% greater than the ZSM-5 zeolite synthesized in the presence of low loading of ODSO, beneficial to allow ingress of large guest species, for example, hydrocarbon molecules, to active sites.

As used herein, “approximately equivalent” as concerning the amount of ODSO that replaces water, the cumulative amount of ODSO and water, the component molar or mass ratios, and/or the hydrolysis conditions and time, is within a margin of less than or equal to plus or minus 1, 2, 5 or 10% of the compared value.

In the description herein, the terms “sol-gel”, “colloidal”, “sol-gel/colloidal”, and “homogeneous aqueous mixture” may be used interchangeably for convenience.

It is to be understood that like numerals in the drawings represent like elements through the several figures, and that not all components and/or steps described and illustrated with reference to the figures are required for all embodiments or arrangements. Further, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “including,” “comprising,” or “having,” “containing,” “involving,” and variations thereof herein, when used in this specification, specify the presence of stated features, integers, steps, operations, elements, and/or components, but do not preclude the presence or addition of one or more other features, integers, steps, operations, elements, components, and/or groups thereof.

Notably, the figures and examples above are not meant to limit the scope of the present disclosure to a single implementation, as other implementations are possible by way of interchange of some or all the described or illustrated elements. Moreover, where certain elements of the present disclosure can be partially or fully implemented using known components, only those portions of such known components that are necessary for an understanding of the present disclosure are described, and detailed descriptions of other portions of such known components are omitted so as not to obscure the disclosure. In the present specification, an implementation showing a singular component should not necessarily be limited to other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present disclosure encompasses present and future known equivalents to the known components referred to herein by way of illustration.

The foregoing description of the specific implementations will so fully reveal the general nature of the disclosure that others can, by applying knowledge within the skill of the relevant art(s), readily modify and/or adapt for various applications such specific implementations, without undue experimentation, without departing from the general concept of the present disclosure. Such adaptations and modifications are therefore intended to be within the meaning and range of equivalents of the disclosed implementations, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s). It is to be understood that dimensions discussed or shown are drawings accordingly to one example and other dimensions can be used without departing from the disclosure.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

TABLE 1

| | Idealized | Crystal | | | | | | |
|---|---|---|---|---|---|---|---|---|
| | cell data | chemical data | # of T | | | | | |
| | a, b and c | a, b and c | atoms | | Framework | | Channel | Channel |
| | parameters | parameters | in unit | Composite | density | Member | size | size |
| | (Å) | (Å) | cell | building units | (T/1000 Å³) | ring size | (Å) | (Å) |
| (MFI) | a = 20.1 | a = 20.07 | 96 | MOR, CAS, | 17.9 | 10 | [100] | [010] |
| | b = 19.7 | b = 19.92 | | MEL, MFI | | | 5.1 × 5.5 | 5.3 × 5.6 |
| | c = 13.1 | c = 13.42 | | | | | | |
| (BEA*) | a = 12.6 | a = 12.661 | 64 | MOR, BEA, | 15.1 | 12 | <100> | [001] |
| | c = 26.2 | c = 26.406 | | MTW | | | 6.6 × 6.7 | 5.6 × 5.6 |
| (FAU) | a = 24.3 | a = 24.74 | 192 | D6R, SOD | 12.7 | 12 | <111> | |
| | | | | | | | 7.4 × 7.4 | |

(MFI), (BEA*) and (FAU) data obtained from Baerlocher, C., McMusker, L. B and Olson, D. “Atlas of Zeolite Framework Types” sixth revised edition, 2007, Elsevier.

TABLE 2
Crystal systems.

| | | Essential symmetry |
|---|---|---|
| System | Unit cell | of crystal |
| Triclinic | No special | None |
| | relationship | |
| Monoclinic | a ≠ b ≠ c | Two-fold axis or mirror plane |
| | α = γ = 90° ≠ β | (inverse two-fold axis) |
| Orthorhombic | a ≠ b ≠ c | Three orthogonal two-fold |
| | α = β = γ = 90° | or inverse two-fold axes |
| Tetragonal | a = b ≠ c | One four-fold or |
| | α = β = γ = 90° | inverse four-fold axis |
| Trigonal | a = b = c | One three-fold axis or |
| | α = β = γ ≠ 90° | inverse three-fold axis |
| Hexagonal | a = b = c | One six-fold or inverse |
| | α = β = 90°, γ = | six-fold axis |
| | 120° | |
| Cubic | a = b = c | Four three-fold axes |

TABLE 3
Crystal classes

| | Crystal classes (point group) | |
|---|---|---|
| System | Non-centrosymmetric | Centrosymmetric |
| Triclinic | 1 | 1̅ |
| Monoclinic | 2, m (= 2̅) | 2/m |
| Orthorhombic | 222, 2 mm | mmm |
| Tetragonal | 4, 4̅ | 4/m |
| | 422, 4 mm, 4̅2 m | 4/mmm |
| Trigonal | 3 | 3̅ |
| | 32, 3 m | 3̅ m |
| Hexagonal | 6, 6̅ | 6/m |
| | 622, 6 mm, 6̅2 m | 6/mmm |
| Cubic | 23 | m3̅ |
| | 432, 4̅3 m | m3̅m |

TABLE 4

| ODSO Name | Formula | Structure Examples |
|---|---|---|
| Dialkyl-sulfonesulfoxide Or 1,2-alkyl-alkyl-disulfane 1,1,2-trioxide | (R—SOO—SO—R′) | 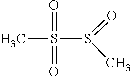 |
| | | 1,2-Dimethyldisulfane 1,1,2-trioxide |
| Dialkyl-disulfone Or 1,2 alkyl-alkyl-disulfane 1,1,2,2-tetraoxide | (R—SOO—SOO—R′) | 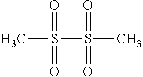 |
| | | 1,2-Dimethyldisulfane 1,1,2,2- |
| | | tetraoxide |
| Alkyl-sulfoxidesulfonate | (R—SO—SOO—OH) | 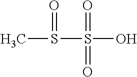 |
| | | Methylsulfanesulfonic acid oxide |
| Alkyl-sulfonesulfonate | (R—SOO—SOO—OH) | 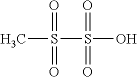 |
| | | 1-Hydroxy-2-methyldisulfane 1,1,2,2- |
| | | tetraoxide |
| Alkyl-sulfoxidesulfinate | (R—SO—SO—OH) | 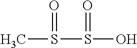 |
| | | 1-Hydroxy-2-methyldisulfane 1,2- |
| | | dioxide |
| Alkyl-sulfonesulfinate | (R—SOO—SO—OH) | 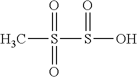 |
| | | Methylsulfanesulfinic acid dioxide |

R and R′ can be the same or different C1-C10 alkyl groups or C6-C10 aryl groups comprising

TABLE 5

| | Beta (absence of | |
|---|---|---|
| | ODSO) | |
| | (Comparative | Beta (ODSO) |
| | Example 1) | (Example 1) |
| BET specific surface area (m²/g) | 611 | 623 |
| Microporous surface area (m²/g) | 494 | 404 |
| Mesoporous surface area (m²/g) | 117 | 219 |
| Contribution of mesoporous surface | 19 | 35 |
| area to total surface area (%) | | |
| Increase of mesoporous surface | — | 84 |
| area contribution (%) | | |
| Total pore volume (cc/g) | 0.28 | 0.36 |
| Microporous volume (cc/g) | 0.20 | 0.16 |
| Mesoporous volume (cc/g) | 0.08 | 0.20 |
| Contribution of mesoporous | 29 | 56 |
| volume to total volume (%) | | |
| Increase of mesoporous volume (%) | — | 150 |

TABLE 6

| | ZSM-5 (absence | |
|---|---|---|
| | of ODSO) | ZSM-5 |
| | (Comparative | (ODSO) |
| | Example 3) | (Example 3) |
| BET specific surface area (m²/g) | 392 | 379 |
| Microporous surface area (m²/g) | 295 | 237 |
| Mesoporous surface area (m²/g) | 97 | 142 |
| Contribution of mesoporous | 25 | 37 |
| surface area to total | | |
| surface area (%) | | |
| Increase of mesoporous surface | — | 48 |
| area contribution (%) | | |
| Total pore volume (cc/g) | 0.19 | 0.23 |
| Microporous volume (cc/g) | 0.11 | 0.10 |
| Mesoporous volume (cc/g) | 0.08 | 0.13 |
| Contribution of mesoporous | 42 | 57 |
| volume to total volume (%) | | |
| Increase of mesoporous | — | 63 |
| volume (%) | | |

TABLE 7

| | ANA (absence | | |
|---|---|---|---|
| | of ODSO) | ZSM-5 | ZSM-5 |
| | (Comparative | (low ODSO) | (high ODSO) |
| | Example 4) | (Example 4A) | (Example 4B) |
| BET specific surface area (m²/g) | — | 147 | 342 |
| Microporous surface area (m²/g) | — | 145 | 330 |
| Mesoporous surface area (m²/g) | — | 2 | 12 |
| Contribution of mesoporous surface area | — | 1 | 4 |
| to total surface area (%) | | | |
| Increase of mesoporous surface area | — | | 500 |
| contribution (%) | | | |
| Total pore volume (cc/g) | 0.01 | 0.06 | 0.15 |
| Microporous volume (cc/g) | — | 0.01 | 0.03 |
| Mesoporous volume (cc/g) | — | 0.05 | 0.12 |
| Contribution of mesoporous volume to | — | 83 | 80 |
| total volume (%) | | | |
| Increase of mesoporous volume (%) | — | — | 140 |

1. A method for synthesis of zeolite comprising:
forming a homogeneous aqueous mixture of a silica source, an optional alumina source, an alkali metal source, an optional structure directing agent, water and water-soluble oxidized disulfide oil (ODSO); and
heating the mixture under conditions and for a time effective to form a precipitate suspended in a supernatant, wherein the precipitate comprises the zeolite, and wherein
the zeolite is hierarchical.

2. The method as in claim 1, wherein the homogeneous aqueous mixture is formed at a compositional ratio effective for the zeolite, wherein a cumulative mass of ODSO and water is equivalent to a mass of water that is effective to produce the zeolite, and where the hierarchical zeolite has a property that is enhanced with respect to that of a comparative zeolite formed in the absence of ODSO and of approximately equivalent compositional ratio, time and conditions effective for the zeolite.

3. A method for synthesis of zeolite comprising:
forming a homogeneous aqueous mixture of a silica source, an optional alumina source, an alkali metal source, an optional structure directing agent, water and water-soluble oxidized disulfide oil (ODSO); and
heating the mixture under conditions and for a time effective to form a precipitate suspended in a supernatant, wherein the precipitate comprises the zeolite, and wherein
the zeolite is formed by a non-classical route.

4. The method of claim 3, wherein a comparative zeolite having a baseline ratio of components including a baseline mass of water and which is formed in the absence of ODSO is formed via a classical route, and wherein a mass of ODSO is of a value such that a cumulative mass of the water in and the mass of ODSO is equivalent to the baseline mass of water.

5-6. (canceled)

7. The method of claim 3, wherein the non-classical route comprises attaching one or more oligomers, primary particles, nanoparticles or other species larger than monomers from the homogeneous aqueous mixture to the zeolite, and wherein the zeolite has a unit cell size and the one or more oligomers, primary particles, nanoparticles or other species larger than monomers has a size that is larger than the unit cell size.

8. The method of claim 7, wherein the species larger than monomers include Si, molecules containing Si, one or more heteroatoms, hydroxides of one or more heteroatoms, oxides of one or more heteroatoms, salts of one or more heteroatoms, or combinations thereof, wherein the one or more heteroatoms are selected from the group consisting of Al, Ti, Zr, Hf, Ge, Ga, Cu, Fe, B, P, Sn, Zn, and In.

9. (canceled)

10. The method of claim 1, wherein the zeolite is formed at a crystallization rate that is greater than that of a comparative zeolite having a baseline ratio of components including a baseline mass of water and which is formed in the absence of ODSO.

11. The method of claim 1, wherein the property that is enhanced is a specific surface area, a total pore volume, a mesoporous volume, a relative contribution of mesopores to a total volume of the zeolite, a mesopore surface area, a relative contribution of mesopores to a total surface area of the zeolite, or a combination thereof; and
wherein the specific surface area of the of the zeolite is in the range of about 1-200% greater than a comparative zeolite, the total pore volume of the zeolite is in the range of about 1-200% greater than a comparative zeolite, the mesoporous volume of the zeolite is in the range of about 1-200% greater than a comparative zeolite, the relative contribution of mesopores to a total volume of the zeolite is in the range of about 1-150% greater than a comparative zeolite, the mesopore surface area of the zeolite is in the range of about 1-750% greater than a comparative zeolite, or the relative contribution of mesopores to a total surface area of the zeolite is in the range of about 1-400% greater than a comparative zeolite;
wherein the comparative zeolite is formed in the absence of ODSO of approximately equivalent compositional ratio effective for the zeolite except for water instead of the added ODSO.

12-17. (canceled)

18. The method of claim 1, wherein ODSO is added in an amount by mass of ODSO, relative to the total mass of “free” water and ODSO, in the range of from about 0.1 to 50%, or in an amount by mass of ODSO, relative to the total mass of water and ODSO, in the range of from about 0.5 to 17%.

19. (canceled)

20. The method of claim 1, wherein the alkali metal comprises sodium, and wherein the zeolite has an ODSO to sodium ratio (wt./wt.) in the range of about 0.01-11.

21. (canceled)

22. The method of claim 3, wherein the zeolite has a morphology that comprises an agglomeration of individual zeolite particles characterized by an agglomeration average dimension, and wherein each individual zeolite particle is characterized by an average dimension that is about 1-99% smaller than the agglomeration average dimension.

23. The method of claim 1, wherein the zeolite is one or more of zeolites identified by the International Zeolite Association, including those with the identifiers ABW, ACO, AEI, AEL, AEN, AET, AFG, AFI, AFN, AFO, AFR, AFS, AFT, AFV, AFX, AFY, AHT, ANA, ANO, APC, APD, AST, ASV, ATN, ATO, ATS, ATT, ATV, AVE, AVL, AWO, AWW, BCT, BEC, BIK, BOF, BOG, BOZ, BPH, BRE, BSV, CAN, CAS, CDO, CFI, CGF, CGS, CHA, —CHI, -CLO, CON, CSV, CZP, DAC, DDR, DFO, DFT, DOH, DON, EAB, EDI, EEI, EMT, EON, EPI, ERI, ESV, ETL, ETR, ETV, EUO, EWO, EWS, EZT, FAR, FAU, FER, FRA, GIS, GIU, GME, GON, GOO, HEU, IFO, IFR, -IFT, —IFU, IFW, IFY, IHW, IMF, IRN, IRR, —IRY, ISV, ITE, ITG, ITH, ITR, ITT, -ITV, ITW, IWR, IWS, IWV, IWW, JBW, JNT, JOZ, JRY, JSN, JSR, JST, JSW, KFI, LAU, LEV, LIO, -LIT, LOS, LOV, LTA, LTF, LTJ, LTL, LTN, MAR, MAZ, MEI, MEL, MEP, MER, MFI, MFS, MON, MOR, MOZ, MRT, MSE, MSO, MTF, MTN, MTT, MTW, MVY, MWF, MWW, NAB, NAT, NES, NON, NPO, NPT, NSI, OBW, OFF, OKO, OSI, OSO, OWE, -PAR, PAU, PCR, PHI, PON, POR, POS, PSI, PTO, PTT, PTY, PUN, PWN, PWO, PWW, RHO, —RON, RRO, RSN, RTE, RTH, RUT, RWR, RWY, SAF, SAO, SAS, SAT, SAV, SBE, SBN, SBS, SBT, SEW, SFE, SFF, SFG, SFH, SFN, SFO, SFS, SFW, SGT, SIV, SOD, SOF, SOR, SOS, SOV, SSF, SSY, STF, STI, STT, STW, —SVR, SVV, SWY, -SYT, SZR, TER, THO, TOL, TON, TSC, TUN, UEI, UFI, UOS, UOV, UOZ, USI, UTL, UWY, VET, VFI, VNI, VSV, WEI, -WEN, YFI, YUG, ZON, *BEA, *CTH, *-EWT, *-ITN, *MRE, *PCS, *SFV, *—SSO, *STO, *—SVY, or *UOE, or one or more zeolites synthesized comprising co-crystallized products of two or more types of zeolites identified above.

24. The method of claim 1, wherein the zeolite possesses MFI, FAU, or *BEA, frameworks.

25. The method of claim 1, wherein the zeolite possesses FAU framework and comprises zeolite Y or ultra-stable zeolite Y (USY).

26. The method of claim 1, wherein the zeolite possesses *BEA framework.

27. The method of claim 1, wherein the zeolite possesses MFI framework and is ZSM-5, Silicalite-1 or TS-1.

28. The method of claim 1, wherein the alkali metal comprises sodium and wherein:
the zeolite is a ZSM-5 zeolite and the mass ratio of ODSO to sodium from the alkali metal source is in the range of about 0.1-10, or
the zeolite is a *BEA zeolite and the mass ratio of ODSO to sodium from the alkali metal source is in the range of about 0.1-10, or
the zeolite is a FAU zeolite and the mass ratio of ODSO to sodium from the alkali metal source is in the range of about 0.1-2.7.

29-34. (canceled)

35. The method of claim 1, wherein the heating is under conditions comprising
an operating pressure in the range of from atmospheric pressure to 17 bar or is at autogenous pressure,
an operating temperature in the range of from 90° C. to 220° C., and
an operating time in the range of from 0.1 to 14 days.

36. The method of claim 1, wherein the ODSO is derived from oxidation of disulfide oil compounds present in an effluent refinery hydrocarbon stream recovered following catalytic oxidation of mercaptans present in a mercaptan-containing hydrocarbon stream.

37. (canceled)

38. The method of claim 1,
wherein the ODSO compounds have 3 or more oxygen atoms and include one or more compounds selected from the group consisting of (R—SOO—SO—R′), (R—SOO—SOO—R′), (R—SO—SOO—OH), (R—SOO—SOO—OH), (R—SOO—SO—OH), (R′—SO—SO—OR), (R′—SOO—SO—OR), (R′—SO—SOO—OR) and (R′—SOO—SOO—OR), wherein R and R′ can be the same or different C1-C10 alkyl or C6-C10 aryl; or
wherein the ODSO compounds have 3 or more oxygen atoms and include two or more compounds selected from the group consisting of (R—SOO—SO—R′), (R—SOO—SOO—R′), (R—SO—SOO—OH), (R—SOO—SOO—OH), (R—SOO—SO—OH), (R′—SO—SO—OR), (R′—SOO—SO—OR), (R′—SO—SOO—OR) and (R′—SOO—SOO—OR), wherein R and R′ can be the same or different C1-C10 alkyl or C6-C10 aryl; or
wherein the ODSO compounds have 3 or more oxygen atoms and include one or more compounds selected from the group consisting of (R—SOO—SO—R′), (R—SOO—SOO—R′), (R—SO—SOO—OH), (R—SOO—SOO—OH), (R—SO—SO—OH), (R—SOO—SO—OH), wherein R and R′ can be the same or different C1-C10 alkyl or C6-C10 aryl; or
wherein the ODSO compounds have 3 or more oxygen atoms and include two or more compounds selected from the group consisting of (R—SOO—SO—R′), (R—SOO—SOO—R′), (R—SO—SOO—OH), (R—SOO—SOO—OH), (R—SO—SO—OH), (R—SOO—SO—OH), wherein R and R′ can be the same or different C1-C10 alkyl or C6-C10 aryl.
